(19) United States
(12) Patent Application Publication
(10) Pub. No.: US 2025/0126613 A1
(43) Pub. Date: Apr. 17, 2025

(54) INDICATING UNUSED TRANSMIT OCCASIONS IN UPLINK CONTROL INFORMATION

(71) Applicant: QUALCOMM Incorporated, San Diego, CA (US)

(72) Inventors: Diana MAAMARI, San Diego, CA (US); Huilin XU, Temecula, CA (US); Linhai HE, San Diego, CA (US)

(21) Appl. No.: 18/486,871

(22) Filed: Oct. 13, 2023

(51) Int. Cl. H04W 72/1268; H04L 5/00; H04W 72/56

(52) U.S. Cl. CPC H04W 72/1268; H04L 5/0048; H04W 72/56

(57) ABSTRACT

Methods, systems, and devices for wireless communications are described. The described techniques provide for a user equipment (UE) to transmit a physical uplink shared channel (PUSCH) occasion skipping uplink control information (UCI) on more than one transmit occasion of a configured grant (CG). For example, the PUSCH occasion skipping UCI may be associated with a priority, and the UE may multiplex the PUSCH occasion skipping UCI with a PUSCH transmission when the UE does not identify another UCI with a higher priority than the PUSCH occasion skipping UCI to multiplex with the PUSCH transmission. In some examples, the priority of the PUSCH occasion skipping UCI may decrease over time (e.g., with each successive slot). In some examples, the UE may identify a gap period, and may transmit a new PUSCH occasion skipping UCI when the gap period has passed.

### FIELD OF TECHNOLOGY

The following relates to wireless communications, including indicating unused transmit occasions in uplink control information (UCI).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support indicating unused transmit occasions in uplink control information (UCI). For example, the described techniques provide for a user equipment (UE) to transmit a physical uplink shared channel (PUSCH) occasion skipping UCI on more than one transmit occasion of a configured grant (CG). For example, the PUSCH occasion skipping UCI may be associated with a priority, and the UE may multiplex the PUSCH occasion skipping UCI with a PUSCH transmission when the UE does not identify another UCI with a higher priority than the PUSCH occasion skipping UCI to multiplex with the PUSCH transmission. In some examples, the priority of the PUSCH occasion skipping UCI may decrease over time (e.g., with each successive slot). In some examples, the UE may identify a gap period (e.g., a period of time over which the quantity of unused slots may change), and may transmit a new PUSCH occasion skipping UCI when the gap period has passed.

A method for wireless communications by a user equipment (UE) is described. The method may include receiving configuration information indicating a configured grant of uplink resources associated with a set of PUSCH transmissions including a set of multiple PUSCH repetitions, selectively multiplexing one or more PUSCH occasion skipping UCI messages with a corresponding one or more PUSCH repetitions of the set of multiple PUSCH repetitions, where the selective multiplexing is according to a priority of each respective UCI message, and transmitting the set of multiple PUSCH repetitions and the one or more PUSCH occasion skipping UCI messages according to the selective multiplexing.

A UE for wireless communications is described. The UE may include one or more memories storing processor executable code, and one or more processors coupled with the one or more memories. The one or more processors may individually or collectively operable to execute the code to cause the UE to receive configuration information indicating a configured grant of uplink resources associated with a set of multiple PUSCH transmissions including a set of multiple PUSCH repetitions, selectively multiplex one or more PUSCH occasion skipping UCI messages with a corresponding one or more PUSCH repetitions of the set of multiple PUSCH repetitions, where the selective multiplexing is according to a priority of each respective UCI message, and transmit the set of multiple PUSCH repetitions and the one or more PUSCH occasion skipping UCI messages according to the selective multiplexing.

Another UE for wireless communications is described. The UE may include means for receiving configuration information indicating a configured grant of uplink resources associated with a set of multiple PUSCH transmissions including a set of multiple PUSCH repetitions, means for selectively multiplexing one or more PUSCH occasion skipping UCI messages with a corresponding one or more PUSCH repetitions of the set of multiple PUSCH repetitions, where the selective multiplexing is according to a priority of each respective UCI message, and means for transmitting the set of multiple PUSCH repetitions and the one or more PUSCH occasion skipping UCI messages according to the selective multiplexing.

A non-transitory computer-readable medium storing code for wireless communications is described. The code may include instructions executable by a processor to receive configuration information indicating a configured grant of uplink resources associated with a set of multiple PUSCH transmissions including a set of multiple PUSCH repetitions, selectively multiplex one or more PUSCH occasion skipping UCI messages with a corresponding one or more PUSCH repetitions of the set of multiple PUSCH repetitions, where the selective multiplexing is according to a priority of each respective UCI message, and transmit the set of multiple PUSCH repetitions and the one or more PUSCH occasion skipping UCI messages according to the selective multiplexing.

In some examples of the method, user equipment (UEs), and non-transitory computer-readable medium described herein, the priority of each respective PUSCH occasion skipping UCI message may be associated with a respective slot of the corresponding one or more PUSCH repetitions.

In some examples of the method, user equipment (UEs), and non-transitory computer-readable medium described herein, a first PUSCH occasion skipping UCI message of the one or more PUSCH occasion skipping UCI messages may be associated with a highest priority of the one or more PUSCH occasion skipping UCI messages, and the priority of each subsequent PUSCH occasion skipping UCI message may be lower than the priority of a respective preceding PUSCH occasion skipping UCI message.

In some examples of the method, user equipment (UEs), and non-transitory computer-readable medium described herein, selectively multiplexing the one or more PUSCH occasion skipping UCI messages may include operations, features, means, or instructions for dropping one or more additional PUSCH occasion skipping UCI messages from a corresponding one or more PUSCH repetitions of the set of multiple PUSCH repetitions in accordance with one or more additional uplink control messages associated with the one or more PUSCH repetitions having a higher priority than the one or more additional PUSCH occasion skipping UCI message.

In some examples of the method, user equipment (UEs), and non-transitory computer-readable medium described herein, selectively multiplexing the one or more PUSCH occasion skipping UCI messages may include operations, features, means, or instructions for dropping one or more additional PUSCH occasion skipping UCI messages from a corresponding one or more PUSCH repetitions of the set of multiple PUSCH repetitions associated with a time gap following a first PUSCH occasion skipping UCI message of the one or more PUSCH occasion skipping UCI messages.

In some examples of the method, user equipment (UEs), and non-transitory computer-readable medium described herein, selectively multiplexing the one or more PUSCH occasion skipping UCI messages may include operations, features, means, or instructions for selectively multiplexing at least one PUSCH occasion skipping UCI message of the one or more PUSCH occasion skipping UCI messages following the first PUSCH occasion skipping UCI message in accordance with an expiration of the time gap.

Some examples of the method, user equipment (UEs), and non-transitory computer-readable medium described herein may further include operations, features, means, or instructions for updating a content of a portion of the one or more PUSCH occasion skipping UCI messages in accordance with a change in a transmit occasion skipping estimate.

In some examples of the method, user equipment (UEs), and non-transitory computer-readable medium described herein, the content of the portion of the one or more PUSCH occasion skipping UCI messages may be updated in accordance with two or more PUSCH repetitions of the set of multiple PUSCH repetitions respectively colliding with different UCI messages and each of the different uplink control information messages may have a higher priority than the two or more PUSCH repetitions.

Some examples of the method, user equipment (UEs), and non-transitory computer-readable medium described herein may further include operations, features, means, or instructions for maintaining a content of at least one PUSCH occasion skipping UCI message of the one or more PUSCH occasion skipping UCI messages constant during a time gap following a first PUSCH occasion skipping UCI message of the one or more PUSCH occasion skipping UCI messages.

Some examples of the method, user equipment (UEs), and non-transitory computer-readable medium described herein may further include operations, features, means, or instructions for updating a content of at least one PUSCH occasion skipping UCI message of the one or more PUSCH occasion skipping UCI messages in accordance with an expiration of the time gap and a change in a transmit occasion skipping estimate.

Some examples of the method, user equipment (UEs), and non-transitory computer-readable medium described herein may further include operations, features, means, or instructions for receiving a radio resource control message indicating whether the UE may be permitted to update a content of the one or more PUSCH occasion skipping UCI messages.

A method for wireless communications by a network entity is described. The method may include transmitting configuration information indicating a configured grant for a UE to transmit a set of multiple PUSCH transmissions including a set of multiple PUSCH repetitions and receiving the set of multiple PUSCH repetitions, where one or more of the set of multiple PUSCH repetitions is multiplexed with one or more PUSCH occasion skipping UCI messages according to a priority of each respective one or more PUSCH occasion skipping UCI message.

A network entity for wireless communications is described. The network entity may include one or more memories storing processor executable code, and one or more processors coupled with the one or more memories. The one or more processors may individually or collectively operable to execute the code to cause the network entity to transmit configuration information indicating a configured grant for a UE to transmit a set of multiple PUSCH transmissions including a set of multiple PUSCH repetitions and receive the set of multiple PUSCH repetitions, where one or more of the set of multiple PUSCH repetitions is multiplexed with one or more PUSCH occasion skipping UCI messages according to a priority of each respective one or more PUSCH occasion skipping UCI message.

Another network entity for wireless communications is described. The network entity may include means for transmitting configuration information indicating a configured grant for a UE to transmit a set of multiple PUSCH transmissions including a set of multiple PUSCH repetitions and means for receiving the set of multiple PUSCH repetitions, where one or more of the set of multiple PUSCH repetitions is multiplexed with one or more PUSCH occasion skipping UCI messages according to a priority of each respective one or more PUSCH occasion skipping UCI message.

A non-transitory computer-readable medium storing code for wireless communications is described. The code may include instructions executable by a processor to transmit configuration information indicating a configured grant for a UE to transmit a set of multiple PUSCH transmissions including a set of multiple PUSCH repetitions and receive the set of multiple PUSCH repetitions, where one or more of the set of multiple PUSCH repetitions is multiplexed with one or more PUSCH occasion skipping UCI messages according to a priority of each respective one or more PUSCH occasion skipping UCI message.

In some examples of the method, network entities, and non-transitory computer-readable medium described herein, the priority of each respective PUSCH occasion skipping UCI message may be associated with a respective slot of a corresponding one or more PUSCH repetitions.

In some examples of the method, network entities, and non-transitory computer-readable medium described herein, a first PUSCH occasion skipping UCI message of the one or more PUSCH occasion skipping UCI messages may be associated with a highest priority of the one or more PUSCH occasion skipping UCI messages, and the priority of each subsequent PUSCH occasion skipping UCI message may be lower than the priority of a respective preceding PUSCH occasion skipping UCI message.

In some examples of the method, network entities, and non-transitory computer-readable medium described herein, receiving the set of multiple PUSCH repetitions may include operations, features, means, or instructions for receiving one or more additional uplink control messages associated with the one or more PUSCH repetitions in accordance with the one or more additional uplink control messages having a higher priority than a portion of one or more additional PUSCH occasion skipping UCI message.

In some examples of the method, network entities, and non-transitory computer-readable medium described herein, receiving the set of multiple PUSCH repetitions may include operations, features, means, or instructions for receiving at least one PUSCH occasion skipping UCI message of the one or more PUSCH occasion skipping UCI messages in accordance with an expiration of a time gap following a first PUSCH occasion skipping UCI message.

In some examples of the method, network entities, and non-transitory computer-readable medium described herein, receiving the set of multiple PUSCH repetitions may include operations, features, means, or instructions for receiving an at least one PUSCH occasion skipping UCI message of the one or more PUSCH occasion skipping UCI messages, where a portion of the at least one PUSCH occasion skipping UCI message may be updated in accordance with a change in an transmit occasion skipping estimate.

In some examples of the method, network entities, and non-transitory computer-readable medium described herein, receiving the at least one PUSCH occasion skipping UCI message may include operations, features, means, or instructions for receiving the at least one PUSCH occasion skipping UCI message in accordance with two or more PUSCH repetitions of the set of multiple PUSCH repetitions respectively colliding with different UCI messages, where each of the different uplink control information messages may have a higher priority than the two or more PUSCH repetitions.

In some examples of the method, network entities, and non-transitory computer-readable medium described herein, receiving the at least one PUSCH occasion skipping UCI message may include operations, features, means, or instructions for receiving the at least one PUSCH occasion skipping UCI message in accordance with an expiration of a time gap.

Some examples of the method, network entities, and non-transitory computer-readable medium described herein may further include operations, features, means, or instructions for transmitting a radio resource control message indicating whether the UE may be permitted to update a content of the one or more PUSCH occasion skipping UCI message.

### BRIEF DESCRIPTION OF THE DRAWINGS

FIG. 1 shows an example of a wireless communications system that supports indicating unused transmit occasions in uplink control information (UCI) in accordance with one or more aspects of the present disclosure.

FIG. 2 shows an example of a wireless communications system that supports indicating unused transmit occasions in UCI in accordance with one or more aspects of the present disclosure.

FIG. 3 shows an example of a slot diagram that supports indicating unused transmit occasions in UCI in accordance with one or more aspects of the present disclosure.

FIG. 4 shows an example of a slot diagram that supports indicating unused transmit occasions in UCI in accordance with one or more aspects of the present disclosure.

FIG. 5 shows an example of a process flow that supports indicating unused transmit occasions in UCI in accordance with one or more aspects of the present disclosure.

FIGS. 6 and 7 show block diagrams of devices that support indicating unused transmit occasions in UCI in accordance with one or more aspects of the present disclosure.

FIG. 8 shows a block diagram of a communications manager that supports indicating unused transmit occasions in UCI in accordance with one or more aspects of the present disclosure.

FIG. 9 shows a diagram of a system including a device that supports indicating unused transmit occasions in UCI in accordance with one or more aspects of the present disclosure.

FIGS. 10 and 11 show block diagrams of devices that support indicating unused transmit occasions in UCI in accordance with one or more aspects of the present disclosure.

FIG. 12 shows a block diagram of a communications manager that supports indicating unused transmit occasions in UCI in accordance with one or more aspects of the present disclosure.

FIG. 13 shows a diagram of a system including a device that supports indicating unused transmit occasions in UCI in accordance with one or more aspects of the present disclosure.

FIGS. 14 through 19 show flowcharts illustrating methods that support indicating unused transmit occasions in UCI in accordance with one or more aspects of the present disclosure.

### DETAILED DESCRIPTION

In some wireless communications systems, a user equipment (UE) may receive a configured grant (CG) from a network entity which may schedule the UE to transmit one or more physical uplink shared channel (PUSCH) transmissions (e.g., PUSCH repetitions) in a group of slots. In some examples, the UE may not use all of the slots in the group of slots. For example, the UE may receive a CG scheduling four slots, and may transmit PUSCH transmissions in the first two slots and not in the last two slots. Accordingly, the UE may transmit PUSCH occasion skipping uplink control information (UCI) (e.g., an unused transmit occasion (UTO) UCI) indicating one or more slots of the CG that the UE intends to skip such that the network entity may reallocate the unused resources. However, in some examples, the unused slots may change. That is, the UE may initially transmit a PUSCH occasion skipping UCI (e.g., in a first slot of the CG) indicating that the UE will use four slots, but may later determine that the UE will use three slots. In such cases, an unused slot may not be reallocated by the network entity, which may result in less efficient resource allocation in the wireless communication system.

Accordingly, techniques described herein may allow for a UE to transmit a PUSCH occasion skipping UCI on more than one transmit occasion of a CG. For example, the PUSCH occasion skipping UCI may be associated with a priority, and the UE may multiplex the PUSCH occasion skipping UCI with a PUSCH transmission when the UE does not identify another UCI with a higher priority than the PUSCH occasion skipping UCI to multiplex with the PUSCH transmission. In some examples, the priority of the PUSCH occasion skipping UCI may decrease over time (e.g., with each successive slot). In some examples, the UE may identify a gap period (e.g., a period of time over which the quantity of unused slots may change), and may transmit a new PUSCH occasion skipping UCI when the gap period has passed.

Aspects of the disclosure are initially described in the context of wireless communications systems. Aspects of the disclosure are further illustrated by and described with reference to slot diagrams and process flow diagrams. Aspects of the disclosure are further illustrated by and described with reference to apparatus diagrams, system diagrams, and flowcharts that relate to indicating unused transmit occasions in UCI.

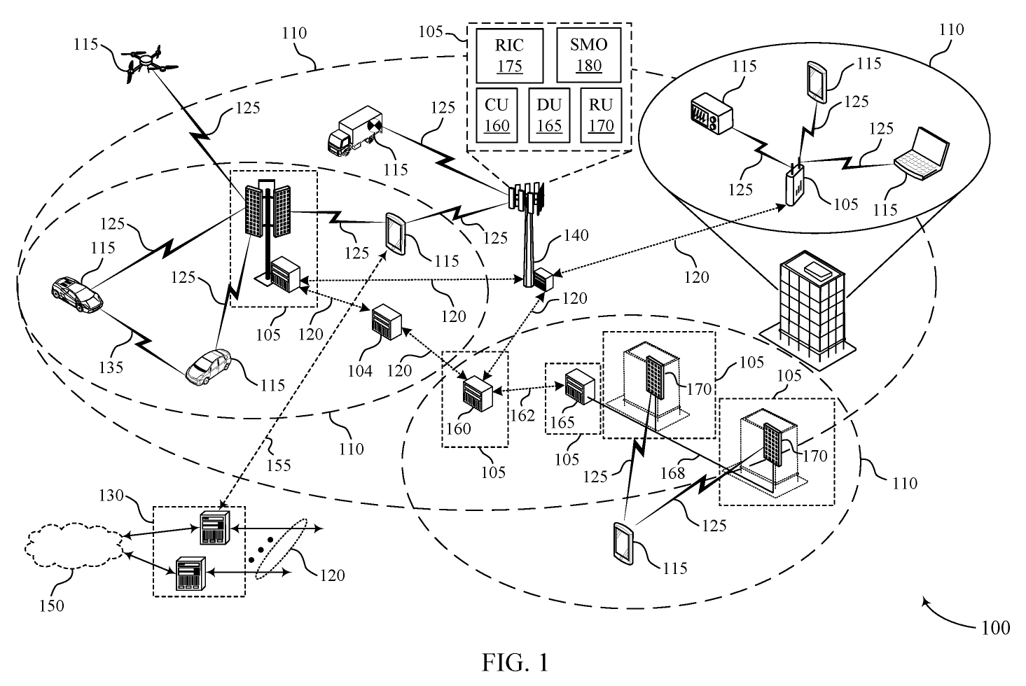

FIG. 1 shows an example of a wireless communications system 100 that supports indicating unused transmit occasions in UCI in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support indicating unused transmit occasions in UCI as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Afmax may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Techniques described herein may allow for a UE 115 to transmit a PUSCH occasion skipping UCI on more than one transmit occasion of a CG. For example, the PUSCH occasion skipping UCI may be associated with a priority, and the UE 115 may multiplex the PUSCH occasion skipping UCI with a PUSCH transmission when the UE 115 does not identify another UCI with a higher priority than the PUSCH occasion skipping UCI to multiplex with the PUSCH transmission. In some examples, the priority of the PUSCH occasion skipping UCI may decrease over time (e.g., with each successive slot). In some examples, the UE 115 may identify a gap period (e.g., a period of time over which the quantity of unused slots may change), and may transmit a new PUSCH occasion skipping UCI when the gap period has passed.

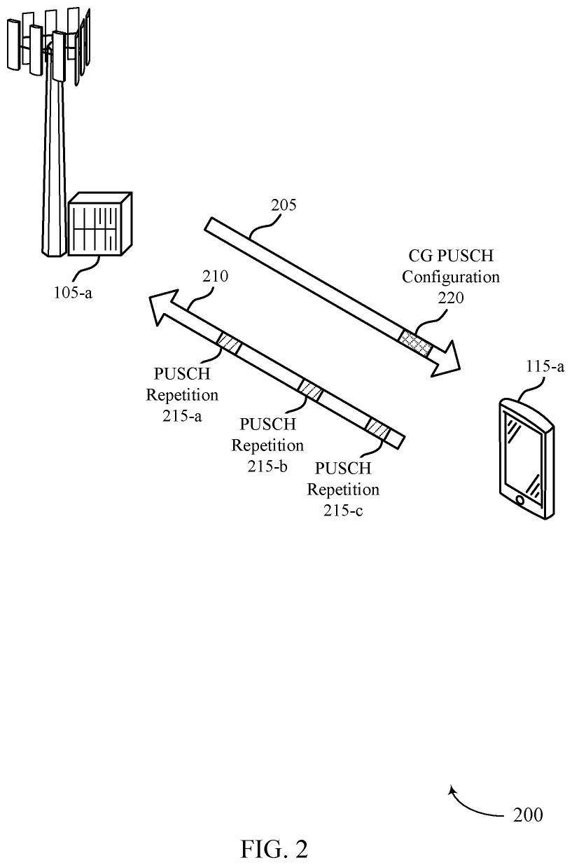

FIG. 2 shows an example of a wireless communications system 200 that supports indicating unused transmit occasions in UCI in accordance with one or more aspects of the present disclosure. The wireless communications system 200 may implement or may be implemented by aspects of the wireless communications system 100. For example, the wireless communications system 200 may include a UE 115 (e.g., a UE 115-a) and a network entity 105 (e.g., a network entity 105-a), which may be examples of the corresponding devices as described with reference to FIG. 1.

In some examples, a UE 115-a may communicate with a network entity 105-a via one or more channels. For example, the UE 115-a may receive one or more transmissions from the network entity 105-a via a downlink channel 205. The UE 115-a may transmit one or more transmissions to the network entity via an uplink channel 210. In some examples, the UE 115-a may receive a CG PUSCH configuration 220 (e.g., via the downlink channel 205) that may schedule multiple occasions for the UE 115-a to transmit one or more PUSCH transmissions (e.g., via the uplink channel 210). In some examples (e.g., to improve a reliability of the network entity 105-a receiving the PUSCH transmissions), the one or more PUSCH transmissions may include PUSCH repetitions 215. That is, if multi-CG PUSCH with repetitions is enabled, the UE 115-a may receive a time domain resource allocation (TDRA) for multiple PUSCH occasions (e.g., to transmit PUSCH repetitions 215) with a single CG PUSCH configuration 220.

However, in some examples, the UE 115-a may not transmit the PUSCH repetitions 215 on all of the scheduled PUSCH occasions. For example, the CG PUSCH configuration 220 may schedule the UE 115-a with four PUSCH occasions, but the UE 115-a may transmit three PUSCH repetitions 215 (e.g., a PUSCH repetition 215-a, a PUSCH repetition 215-b, and a PUSCH repetition 215-c). In such examples, the UE 115-a may indicate unused transmit occasions to the network entity 105-a by transmitting a skipping indication (e.g., a UTO-UCI). For example, the UE 115-a may transmit a PUSCH occasion skipping UCI multiplexed on one or more of the PUSCH repetitions 215 (e.g., in addition to or instead of a PUSCH occasion skipping UCI transmitted on a physical uplink control channel (PUCCH)). Accordingly, the network entity 105-a may utilize (e.g., recycle, reallocate) the unused transmit occasions for other UEs 115, which may increase an overall capacity of the wireless communications system 200. In some examples, the PUSCH occasion skipping UCI may include a bitmap. For example, the bitmap may have one or more bits (e.g., in a sliding window or a fixed bitmap) for indicating the skipped PUSCH occasions (e.g., the unused transmit occasions).

The network entity 105-a and the UE 115-a may determine which PUSCH repetitions 215 the UE 115-a will multiplex with PUSCH occasion skipping UCI (e.g., to avoid ambiguity). In some examples, the UE 115-a may multiplex the PUSCH occasion skipping UCI on one PUSCH repetition 215, on a subset of the PUSCH repetitions 215, or on all PUSCH repetitions 215. In some examples, if the UE 115-a multiplexes PUSCH occasion skipping UCI on one PUSCH repetition 215 (e.g., the PUSCH repetition 215-a), information in the PUSCH occasion skipping UCI may change. That is, the UE 115-a may indicate in the PUSCH occasion skipping UCI that the UE 115-a will transmit PUSCH repetitions 215 on four PUSCH occasions, but may later determine that the UE 115-a will transmit PUSCH repetitions 215 three PUSCH occasions. Accordingly, some PUSCH occasions may not be reallocated by the network entity 105-a, which may decrease an efficiency of resource allocation in the wireless communications system 200.

Thus, the UE 115-a may transmit PUSCH occasion skipping UCI on more than one PUSCH repetition 215 to allow for updated PUSCH occasion skipping information (e.g., and to increase a reliability of the network entity 105-a receiving the PUSCH occasion skipping UCI). However, in some examples, the UE 115-a may identify one or more other UCIs (e.g., non-PUSCH occasion skipping UCIs) which the UE 115-a may multiplex with the PUSCH repetitions 215. Thus, if the UE 115-a transmits PUSCH occasion skipping UCI on all of the PUSCH repetitions 215 (e.g., and the PUSCH occasion skipping UCI has a same priority as the PUSCH repetitions 215), the other UCIs may be canceled if multiplexing multiple UCIs is not enabled.

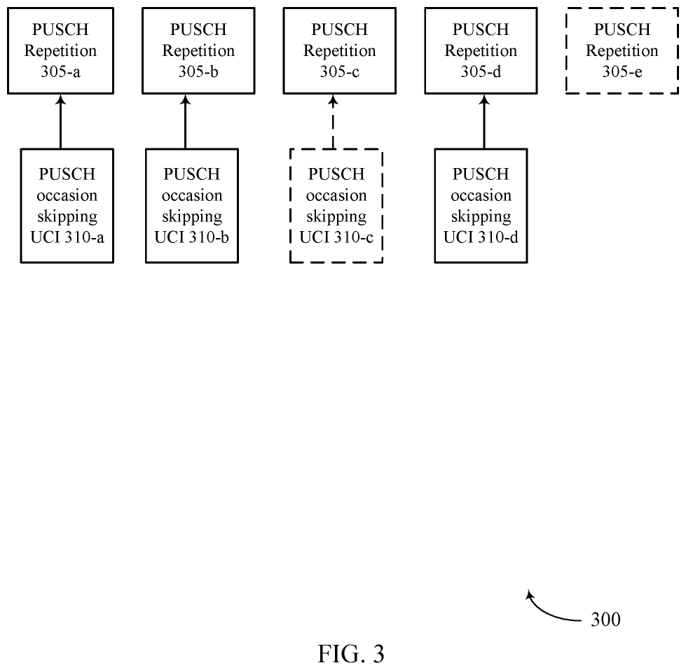

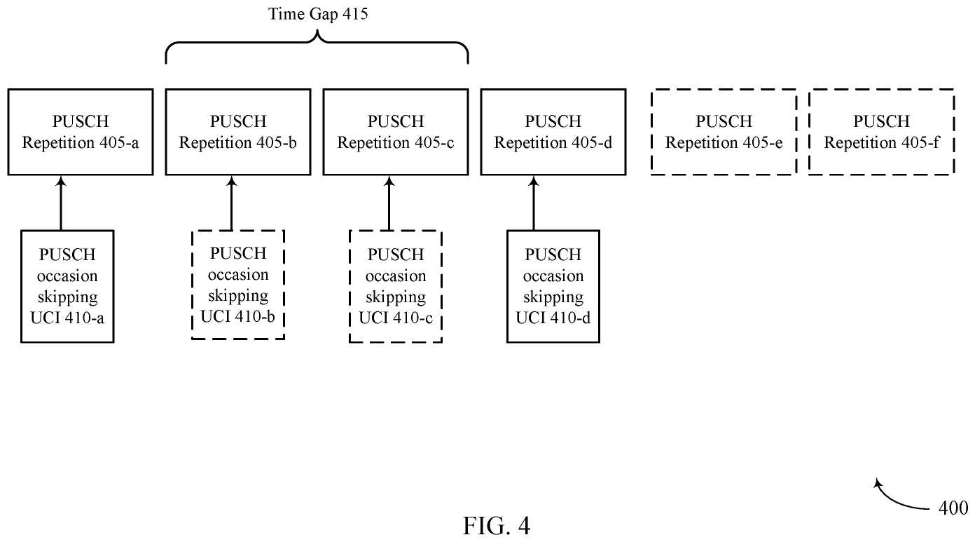

Accordingly, techniques described herein may allow for the UE 115-a and the network entity 105-a to determine whether the UE 115-a will multiplex the PUSCH occasion skipping UCI with a PUSCH repetition 215 based on a priority of the PUSCH occasion skipping UCI (e.g., which may be different from the priority of the PUSCH repetitions 215). For example, the UE 115-a may determine a priority for a first PUSCH occasion skipping UCI to be multiplexed with the PUSCH repetition 215-a, a priority for a second PUSCH occasion skipping UCI to be multiplexed with the PUSCH repetition 215-b which may be lower than the priority for the first PUSCH occasion skipping UCI, and so on. In some examples, the UE 115-a may not multiplex PUSCH occasion skipping UCI during a time gap (e.g., beginning after the PUSCH repetition 215-a), and may multiplex PUSCH occasion skipping UCI with one or more PUSCH repetitions 215 following the time gap. Such techniques are described in further detail herein with reference to FIGS. 3 and 4.

In some examples, the UE 115-a may determine whether to update a content of the PUSCH occasion skipping UCI. That is, if the UE 115-a determines new PUSCH occasion skipping information, the UE 115-a may determine whether to multiplex a same PUSCH occasion skipping UCI with the PUSCH repetition 215-a, with the PUSCH repetition 215-b, and with the PUSCH repetition 215-c or whether to transmit a different PUSCH occasion skipping UCI on one or more of the PUSCH repetition 215-b and the PUSCH repetition 215-c. The UE 115-a may determine whether to update the PUSCH occasion skipping UCI based on one or more of the time gap, a priority of the PUSCH repetitions and one or more other UCI, a RRC configuration, etc. Such techniques are described in further detail herein with reference to FIG. 4.

FIG. 3 shows an example of a slot diagram 300 that supports indicating unused transmit occasions in UCI in accordance with one or more aspects of the present disclosure. The slot diagram 300 may implement or may be implemented by aspects of the wireless communications system 100 or the wireless communications system 200. For example, the slot diagram 300 may be implemented by a UE 115 and a network entity 105, which may be examples of the corresponding devices as described with reference to FIG. 1.

In some examples, a UE 115 may receive, from a network entity 105, a CG for transmitting one or more PUSCH repetitions. For example, the CG may indicate resources for the UE 115 to transmit a PUSCH repetition 305-a, a PUSCH repetition 305-b, a PUSCH repetition 305-c, a PUSCH repetition 305-d, and a PUSCH repetition 305-e. In some examples, the UE 115 may determine one or more PUSCH occasions of the CG via which the UE 115 may not transmit a PUSCH repetition 305. That is, the UE 115 may skip transmitting the PUSCH repetition 305-e. In such examples, the UE 115 may transmit a PUSCH occasion skipping UCI 310 (e.g., a UTO-UCI) with one or more of the PUSCH repetitions 305.

In some examples, the UE 115 may determine a PUSCH occasion skipping UCI 310 corresponding to each PUSCH repetition 305. For example, the UE 115 may determine a PUSCH occasion skipping UCI 310-a corresponding to the PUSCH repetition 305-a, a PUSCH occasion skipping UCI 310-b corresponding to the PUSCH repetition 305-b, a PUSCH occasion skipping UCI 310-c corresponding to the PUSCH repetition 305-c, and a PUSCH occasion skipping UCI 310-d corresponding to the PUSCH repetition 305-d.

In some examples, each of the PUSCH occasion skipping UCIs 310 may be associated with a priority. In such examples, the properties of the PUSCH occasion skipping UCIs 310 may decrease with each subsequent slot such that the priority of each subsequent PUSCH occasion skipping UCI 310 is lower than the priority of a respective preceding PUSCH occasion skipping UCI 310. For example, the PUSCH occasion skipping UCI 310-a may have a highest priority of the PUSCH occasion skipping UCIs 310, the PUSCH occasion skipping UCI 310-b may have a lower priority than the PUSCH occasion skipping UCI 310-a, the PUSCH occasion skipping UCI 310-c may have a lower priority than the PUSCH occasion skipping UCI 310-b, and the PUSCH occasion skipping UCI 310-d may have a lower priority than the PUSCH occasion skipping UCI 310-c. In some examples, the priority of the PUSCH occasion skipping UCI 310-a may be a same priority as the PUSCH repetition 305-a. In some examples, two or more PUSCH occasion skipping UCIs 310 may have the same priority. For example, PUSCH occasion skipping UCI 310-a may have a highest priority of the PUSCH occasion skipping UCIs 310, and PUSCH occasion skipping UCI 310-b. PUSCH occasion skipping UCI 310-c, and PUSCH occasion skipping UCI 310-c may have the same priority, which is lower than the priority of PUSCH occasion skipping UCI 310-a.

In such examples, the UE 115 may drop one or more of the PUSCH occasion skipping UCIs 310 based on identifying one or more other UCI messages that have a higher priority than the PUSCH occasion skipping UCIs 310. For example, if the UE 115 identifies a UCI scheduled for PUSCH repetition 305-c with a higher priority than the PUSCH occasion skipping UCI 310-c, the UE 115 may implement a collision resolution protocol to drop the PUSCH occasion skipping UCI 310-c and instead multiplex the higher priority UCI with the PUSCH repetition 305-c. Alternatively, if the UE 115 identifies another UCI scheduled for PUSCH repetition 305-c with a lower priority than the PUSCH occasion skipping UCI 310-c, the UE 115 may implement the collision resolution protocol drop the other UCI in favor of multiplexing the PUSCH occasion skipping UCI 310-c with the PUSCH repetition 305-c. The collision resolution protocol may include a standardized set of rules based on a comparison of the relative priorities assigned to UCIs scheduled for transmission on the same or overlapping resources.

FIG. 4 shows an example of a slot diagram 400 that supports indicating unused transmit occasions in UCI in accordance with one or more aspects of the present disclosure. The slot diagram 400 may implement or may be implemented by aspects of the wireless communications system 100, the wireless communications system 200, or the slot diagram 300. For example, the slot diagram 400 may be implemented by a UE 115 and a network entity 105, which may be examples of the corresponding devices as described with reference to FIG. 1.

In some examples, a UE 115 may receive, from a network entity 105, a CG for transmitting one or more PUSCH repetitions. For example, the CG may indicate resources for the UE 115 to transmit a PUSCH repetition 405-a, a PUSCH repetition 405-b, a PUSCH repetition 405-c, a PUSCH repetition 405-d, a PUSCH repetition 405-c, and a PUSCH repetition 405-f. In some examples, the UE 115 may determine one or more PUSCH occasions via which the UE 115 may not transmit a PUSCH repetition 405. That is, the UE 115 may skip transmitting a PUSCH repetition 405-e and the PUSCH repetition 405-f. In such examples, the UE 115 may transmit a PUSCH occasion skipping UCI 410 (e.g., a UTO-UCI) with one or more of the PUSCH repetitions 405.

In some examples, the UE 115 may determine a PUSCH occasion skipping UCI 410 corresponding to each PUSCH repetition 405. For example, the UE 115 may determine a PUSCH occasion skipping UCI 410-a corresponding to the PUSCH repetition 405-a, a PUSCH occasion skipping UCI 410-b corresponding to the PUSCH repetition 405-b, a PUSCH occasion skipping UCI 410-c corresponding to the PUSCH repetition 405-c, and a PUSCH occasion skipping UCI 410-d corresponding to the PUSCH repetition 405-d.

In some aspects, channel conditions (e.g., traffic predictions) may change with time. That is, the UE 115 may determine a clearer estimation of which PUSCH occasions the UE 115 will skip after transmitting the PUSCH repetition 405-c as compared to before transmitting the PUSCH repetition 405-a (e.g., due to time elapsed as a result of a time division duplex (TDD) slot configuration with downlink slots between each uplink slot or due to scheduling of non-consecutive PUSCH occasions). The UE 115 may therefore determine an updated estimate of skipped PUSCH occasions after transmitting the PUSCH repetition 405-a (e.g., and the PUSCH occasion skipping UCI 410-a). Accordingly, the UE 115 may determine a time gap 415 after transmitting the PUSCH repetition 405-a, and may update and transmit a PUSCH occasion skipping UCI with an updated content (e.g., the PUSCH occasion skipping UCI 410-d) after the time gap 415. That is, the UE 115 may drop one or more PUSCH occasion skipping UCIs 410 (e.g., the PUSCH occasion skipping UCI 410-b and the PUSCH occasion skipping UCI 410-c) during the time gap 415, and may update and transmit one or more PUSCH occasion skipping UCIs 410 after the time gap 415.

As an illustrative example, the UE 115 may initially determine that the UE 115 will transmit PUSCH repetitions 405 on each PUSCH occasion indicated by the CG. The UE 115 may accordingly transmit the PUSCH occasion skipping UCI 410-a with a bitmap such as [1, 1, 1, 1, 1, 1] to indicate to the network entity 105 that the UE 115 will use each PUSCH occasion. The UE 115 may determine after the time gap 415 that the UE 115 will not transmit the PUSCH repetition 405-e and the PUSCH repetition 405-d. The UE 115 may accordingly transmit the PUSCH occasion skipping UCI 410-d with a bitmap such as [1, 1, 1, 1, 0, 0] to indicate to the network entity 105 that the UE 115 will not use two of the PUSCH occasions.

Additionally, or alternatively, the UE 115 may determine whether the UE 115 may update a content of one or more of the PUSCH occasion skipping UCIs 410. That is, the UE 115 may multiplex a PUSCH occasion skipping UCI 410 with each corresponding PUSCH repetition 405, and may maintain a content of each PUSCH occasion skipping UCI 410 unless one or more criteria are satisfied. That is, the network entity 105 may not expect the UE 115 to update the PUSCH occasion skipping UCIs 410 unless the criteria are satisfied. Such techniques may increase a reliability that the network entity 105 will receive the PUSCH occasion skipping UCIs 410.

For example, the UE 115 may update a PUSCH occasion skipping UCI 410 after the time gap 415 (e.g., after transmitting the PUSCH repetition 405-a and the PUSCH occasion skipping UCI 410-a). Accordingly, the UE 115 may have time to change the PUSCH occasion skipping estimate (e.g., due to time elapsed as a result of a TDD slot configuration with downlink slots between each uplink slot or due to scheduling of non-consecutive PUSCH occasions). The UE 115 may update a PUSCH occasion skipping UCI 410 if different PUSCH repetitions 405 collide (e.g., in time) with one or more higher priority UCI. The UE 115 may receive a configuration (e.g., an RRC configuration) from the network entity 105 indicating whether the UE 115 is enabled to update the content of the PUSCH occasion skipping UCI 410.

As an illustrative example, the UE 115 may initially determine that the UE 115 will transmit PUSCH repetitions 405 on each PUSCH occasion indicated by the CG. The UE 115 may accordingly transmit the PUSCH occasion skipping UCI 410-a, the PUSCH occasion skipping UCI 410-a, and the PUSCH occasion skipping UCI 410-c with a bitmap such as [1, 1, 1, 1, 1, 1] to indicate to the network entity 105 that the UE 115 will use each PUSCH occasion. If one or more of the criteria described herein are satisfied, the UE 115 may determine (e.g., after the time gap 415) that the UE 115 will not transmit the PUSCH repetition 405-e and the PUSCH repetition 405-d. The UE 115 may accordingly update and transmit the PUSCH occasion skipping UCI 410-d with a bitmap such as [1, 1, 1, 1, 0, 0] to indicate to the network entity 105 that the UE 115 will not use two of the PUSCH occasions.

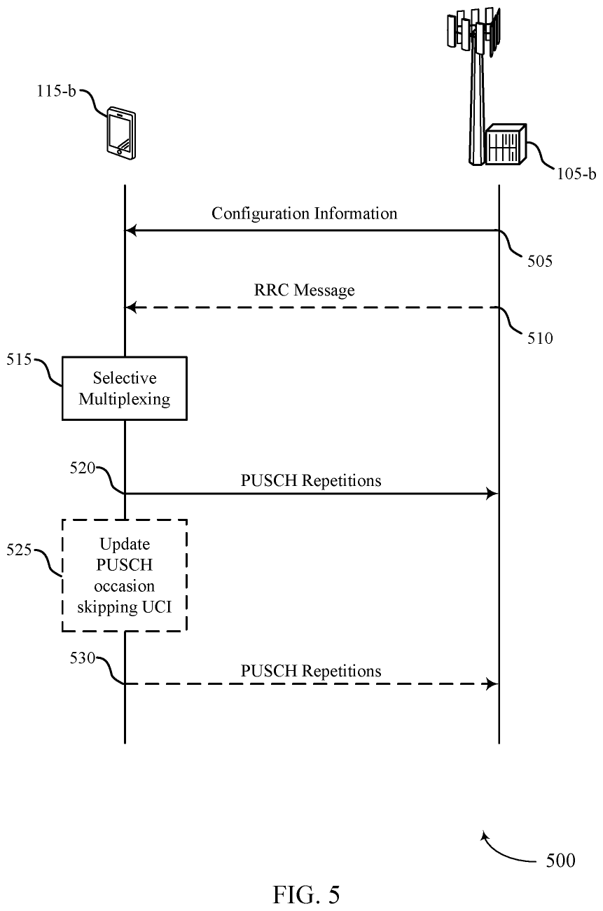

FIG. 5 shows an example of a process flow 500 that supports indicating unused transmit occasions in UCI in accordance with one or more aspects of the present disclosure. The process flow 500 may implement or may be implemented by aspects of the wireless communications system 100, the wireless communications system 200, the slot diagram 300, or the slot diagram 400. For example, the process flow 500 may include a UE 115 (e.g., a UE 115-b) and a network entity 105 (e.g., a network entity 105-b), which may be examples of the corresponding devices as described with reference to FIG. 1.

In the following description of the process flow 500, the operations between the UE 115-b and the network entity 105-b may be transmitted in a different order than the example order shown. Some operations may also be omitted from the process flow 500, and other operations may be added to the process flow 500. Further, although some operations or signaling may be shown to occur at different times for discussion purposes, these operations may actually occur at the same time.

At 505, the UE 115-b may receive, from the network entity 105-b, configuration information indicating a CG of uplink resources for a plurality of PUSCH transmissions. In some examples, the plurality of PUSCH transmissions may include a plurality of PUSCH repetitions.

In some examples, at 510, the UE 115-b may receive, from the network entity 105-b, a control message indicating whether the UE 115-b is permitted to update a content of one or more PUSCH occasion skipping UCI messages. That is, the control message may indicate if the UE 115-b may transmit a first PUSCH occasion skipping UCI message with a first content and a second PUSCH occasion skipping UCI message with an updated content. The control message may be, for example, an RRC message.

At 515, the UE 115-b may selectively multiplex one or more PUSCH occasion skipping UCI messages with corresponding ones of the plurality of PUSCH repetitions. For example, the UE 115-b may determine a priority associated with each of the one or more PUSCH occasion skipping UCI messages. In some examples, the priority of each respective PUSCH occasion skipping UCI message may be based on a slot of the corresponding PUSCH repetition. For example, a first PUSCH occasion skipping UCI message may be associated with a highest priority (e.g., a same priority as the corresponding PUSCH repetition), a second PUSCH occasion skipping UCI message may be associated with a second highest priority, and so on such that each successive PUSCH occasion skipping UCI message has a lower priority than a respective preceding PUSCH occasion skipping UCI message.

In some examples, to perform the selective multiplexing, the UE 115-b may drop one or more additional PUSCH occasion skipping UCI messages from a corresponding one or more PUSCH repetitions. That is, the UE 115-b may drop the one or more additional PUSCH occasion skipping UCI messages if the UE 115-b identifies one or more additional UCI messages that are associated with a higher priority than the one or more dropped PUSCH occasion skipping UCI messages. The UE 115-b may accordingly instead multiplex the one or more additional UCI messages with the corresponding one or more PUSCH repetitions.

In some examples, the UE 115-b may drop the one or more additional PUSCH occasion skipping UCI messages associated with a time gap following the first PUSCH occasion skipping UCI message. That is, the UE 115-b may not multiplex the one or more additional PUSCH occasion skipping UCI messages with the corresponding one or more PUSCH repetitions if the corresponding one or more PUSCH repetitions fall within the time gap. The UE 115-b may multiplex one or more of the one or more PUSCH occasion skipping UCI messages with corresponding ones of the plurality of PUSCH repetitions after an expiration of the time gap.

At 520, the UE 115-b may transmit, to the network entity 105-b, one or more of the plurality of PUSCH repetitions and corresponding ones of the one or more PUSCH occasion skipping UCI messages. The UE 115-b may transmit the one or more additional UCI messages (e.g., if the one or more additional UCI messages have a higher priority than one or more PUSCH occasion skipping UCI messages). In some examples, the UE 115-b may maintain a content of the one or more PUSCH occasion skipping UCI messages during a time gap following the first PUSCH occasion skipping UCI message.

In some examples, at 525, the UE 115-b may update a content of a portion of the one or more PUSCH occasion skipping UCI messages. That is, the UE 115-b may update the content to reflect a change in a transmit occasion skipping estimate. The UE 115-b may update the content in accordance with the RRC message. The UE 115-b may update the content based on expiration of the time gap. The UE 115-b may update the content in accordance with two or more PUSCH repetitions of the plurality of PUSCH repetitions respectively colliding with different uplink control messages (e.g., if the different uplink control messages each have a higher priority than the colliding two or more PUSCH repetitions).

In some examples, at 530, the UE 115-b may transmit, to the network entity 105-b, the updated one or more PUSCH occasion skipping UCI messages. That is, the UE 115-b may multiplex the updated one or more PUSCH occasion skipping UCI messages with one or more corresponding PUSCH repetitions and may transmit the one or more corresponding PUSCH repetitions to the network entity 105-b.

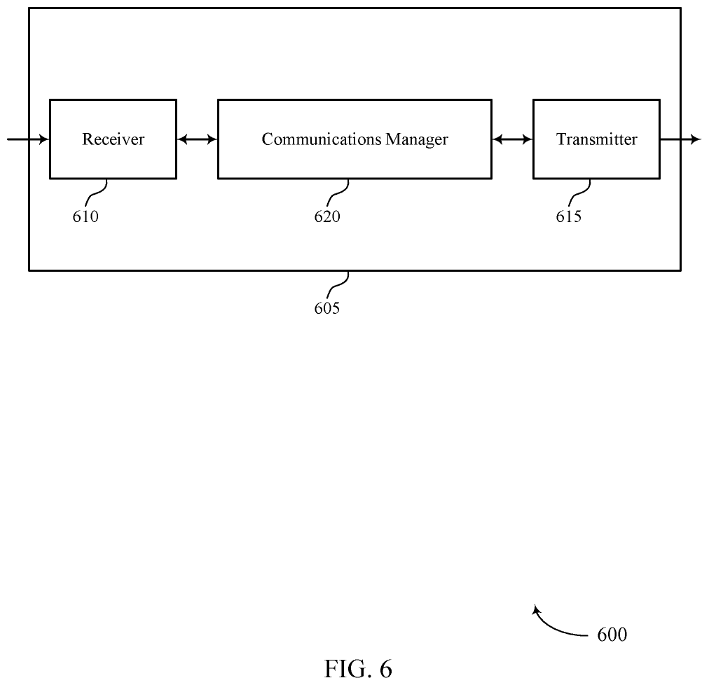

FIG. 6 shows a block diagram 600 of a device 605 that supports indicating unused transmit occasions in UCI in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor (not shown), which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to indicating unused transmit occasions in UCI). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to indicating unused transmit occasions in UCI). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of indicating unused transmit occasions in UCI as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (not shown) (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving configuration information indicating a CG of uplink resources associated with a set of multiple PUSCH transmissions including a set of multiple PUSCH repetitions. The communications manager 620 is capable of, configured to, or operable to support a means for selectively multiplexing one or more PUSCH occasion skipping UCI messages with a corresponding one or more PUSCH repetitions of the set of multiple PUSCH repetitions, where the selective multiplexing is according to a priority of each respective UCI message. The communications manager 620 is capable of, configured to, or operable to support a means for transmitting the set of multiple PUSCH repetitions and the one or more PUSCH occasion skipping UCI messages according to the selective multiplexing.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for transmitting PUSCH occasion skipping UCI with PUSCH repetitions, which may provide for more efficient utilization of communication resources.

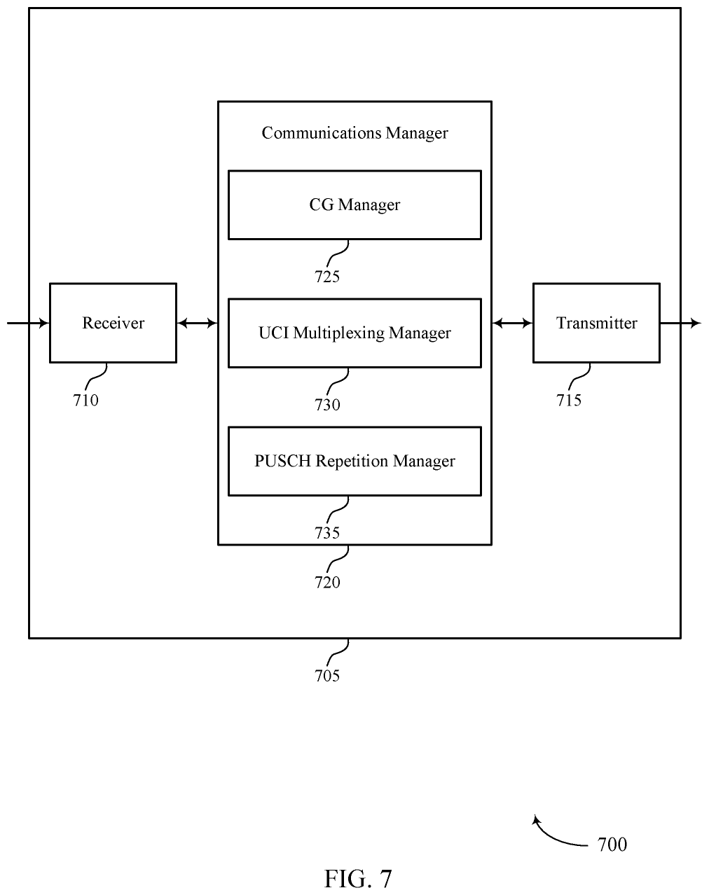

FIG. 7 shows a block diagram 700 of a device 705 that supports indicating unused transmit occasions in UCI in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor (not shown), which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to indicating unused transmit occasions in UCI). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to indicating unused transmit occasions in UCI). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of indicating unused transmit occasions in UCI as described herein. For example, the communications manager 720 may include a CG manager 725, a UCI multiplexing manager 730, a PUSCH repetition manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The CG manager 725 is capable of, configured to, or operable to support a means for receiving configuration information indicating a CG of uplink resources associated with a set of multiple PUSCH transmissions including a set of multiple PUSCH repetitions. The UCI multiplexing manager 730 is capable of, configured to, or operable to support a means for selectively multiplexing one or more PUSCH occasion skipping UCI messages with a corresponding one or more PUSCH repetitions of the set of multiple PUSCH repetitions, where the selective multiplexing is according to a priority of each respective UCI message. The PUSCH repetition manager 735 is capable of, configured to, or operable to support a means for transmitting the set of multiple PUSCH repetitions and the one or more PUSCH occasion skipping UCI messages according to the selective multiplexing.

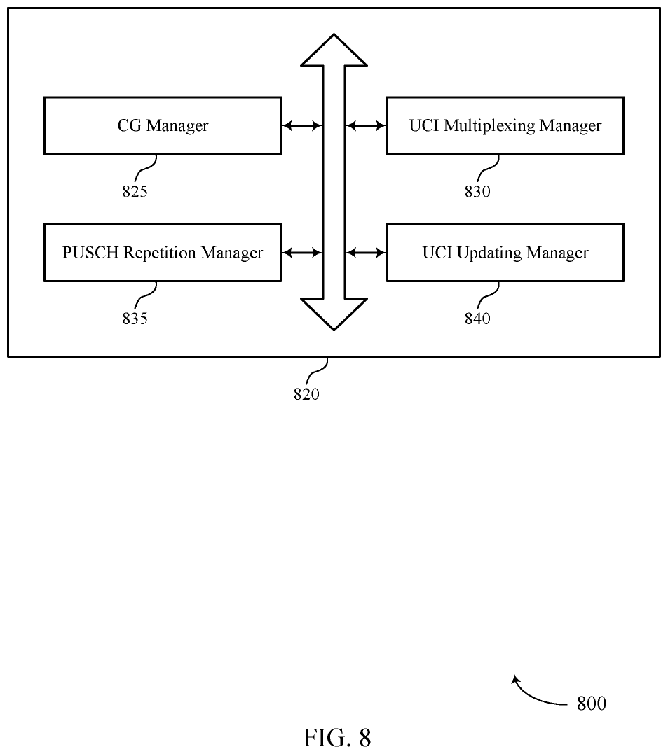

FIG. 8 shows a block diagram 800 of a communications manager 820 that supports indicating unused transmit occasions in UCI in accordance with one or more aspects of the present disclosure. The communications manager 820 may be an example of aspects of a communications manager 620, a communications manager 720, or both, as described herein. The communications manager 820, or various components thereof, may be an example of means for performing various aspects of indicating unused transmit occasions in UCI as described herein. For example, the communications manager 820 may include a CG manager 825, a UCI multiplexing manager 830, an PUSCH repetition manager 835, a UCI updating manager 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The CG manager 825 is capable of, configured to, or operable to support a means for receiving configuration information indicating a CG of uplink resources associated with a set of multiple PUSCH transmissions including a set of multiple PUSCH repetitions. The UCI multiplexing manager 830 is capable of, configured to, or operable to support a means for selectively multiplexing one or more PUSCH occasion skipping UCI messages with a corresponding one or more PUSCH repetitions of the set of multiple PUSCH repetitions, where the selective multiplexing is according to a priority of each respective UCI message. The PUSCH repetition manager 835 is capable of, configured to, or operable to support a means for transmitting the set of multiple PUSCH repetitions and the one or more PUSCH occasion skipping UCI messages according to the selective multiplexing.

In some examples, the priority of each respective PUSCH occasion skipping UCI message is associated with a respective slot of the corresponding one or more PUSCH repetitions.

In some examples, a first PUSCH occasion skipping UCI message of the one or more PUSCH occasion skipping UCI messages is associated with a highest priority of the one or more PUSCH occasion skipping UCI messages, and the priority of each subsequent PUSCH occasion skipping UCI message is lower than the priority of a respective preceding PUSCH occasion skipping UCI message.

In some examples, to support selectively multiplexing the one or more PUSCH occasion skipping UCI messages, the UCI multiplexing manager 830 is capable of, configured to, or operable to support a means for dropping one or more additional PUSCH occasion skipping UCI messages from a corresponding one or more PUSCH repetitions of the set of multiple PUSCH repetitions in accordance with one or more additional uplink control messages associated with the one or more PUSCH repetitions having a higher priority than the one or more additional PUSCH occasion skipping UCI message.

In some examples, to support selectively multiplexing the one or more PUSCH occasion skipping UCI messages, the UCI multiplexing manager 830 is capable of, configured to, or operable to support a means for dropping one or more additional PUSCH occasion skipping UCI messages from a corresponding one or more PUSCH repetitions of the set of multiple PUSCH repetitions associated with a time gap following a first PUSCH occasion skipping UCI message of the one or more PUSCH occasion skipping UCI messages.

In some examples, to support selectively multiplexing the one or more PUSCH occasion skipping UCI messages, the UCI multiplexing manager 830 is capable of, configured to, or operable to support a means for selectively multiplexing at least one PUSCH occasion skipping UCI message of the one or more PUSCH occasion skipping UCI messages following the first PUSCH occasion skipping UCI message in accordance with an expiration of the time gap.

In some examples, the UCI updating manager 840 is capable of, configured to, or operable to support a means for updating a content of a portion of the one or more PUSCH occasion skipping UCI messages in accordance with a change in a transmit occasion skipping estimate.

In some examples, the content of the portion of the one or more PUSCH occasion skipping UCI messages is updated in accordance with two or more PUSCH repetitions of the set of multiple PUSCH repetitions respectively colliding with different UCI messages. In some examples, each of the different uplink control information messages has a higher priority than the two or more PUSCH repetitions.

In some examples, the UCI updating manager 840 is capable of, configured to, or operable to support a means for maintaining a content of at least one PUSCH occasion skipping UCI message of the one or more PUSCH occasion skipping UCI messages constant during a time gap following a first PUSCH occasion skipping UCI message of the one or more PUSCH occasion skipping UCI messages.

In some examples, the UCI updating manager 840 is capable of, configured to, or operable to support a means for updating a content of at least one PUSCH occasion skipping UCI message of the one or more PUSCH occasion skipping UCI messages in accordance with an expiration of the time gap and a change in a transmit occasion skipping estimate.

In some examples, the UCI updating manager 840 is capable of, configured to, or operable to support a means for receiving a radio resource control message indicating whether the UE is permitted to update a content of the one or more PUSCH occasion skipping UCI messages.

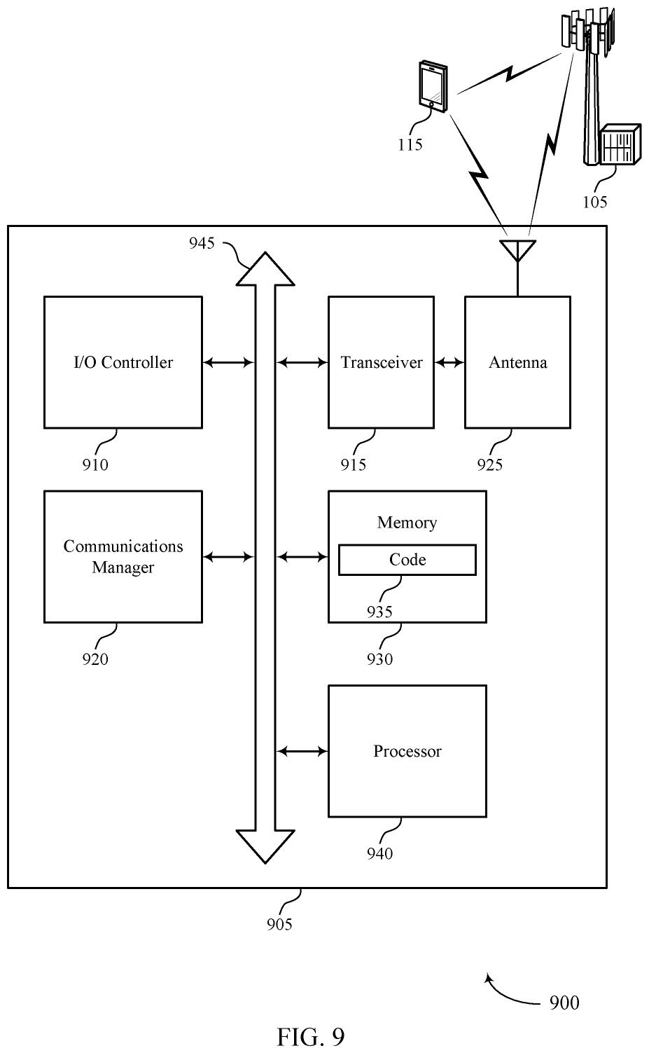

FIG. 9 shows a diagram of a system 900 including a device 905 that supports indicating unused transmit occasions in UCI in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem (not shown) to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (not shown) (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting indicating unused transmit occasions in UCI). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors 940 and the at least one memory 930 may include multiple memories 930. One or more of the multiple processors 940 may be coupled with one or more of the multiple memories 930, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving configuration information indicating a CG of uplink resources associated with a set of multiple PUSCH transmissions including a set of multiple PUSCH repetitions. The communications manager 920 is capable of, configured to, or operable to support a means for selectively multiplexing one or more PUSCH occasion skipping UCI messages with a corresponding one or more PUSCH repetitions of the set of multiple PUSCH repetitions, where the selective multiplexing is according to a priority of each respective UCI message. The communications manager 920 is capable of, configured to, or operable to support a means for transmitting the set of multiple PUSCH repetitions and the one or more PUSCH occasion skipping UCI messages according to the selective multiplexing.

By including or configuring the communications manager 920 in accordance with examples as described herein, the device 905 may support techniques for transmitting PUSCH occasion skipping UCI with PUSCH repetitions, which may provide for improved communication reliability and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of indicating unused transmit occasions in UCI as described herein, or the at least one processor 940 and the at least one memory 930 may be otherwise configured to, individually or collectively, perform or support such operations.

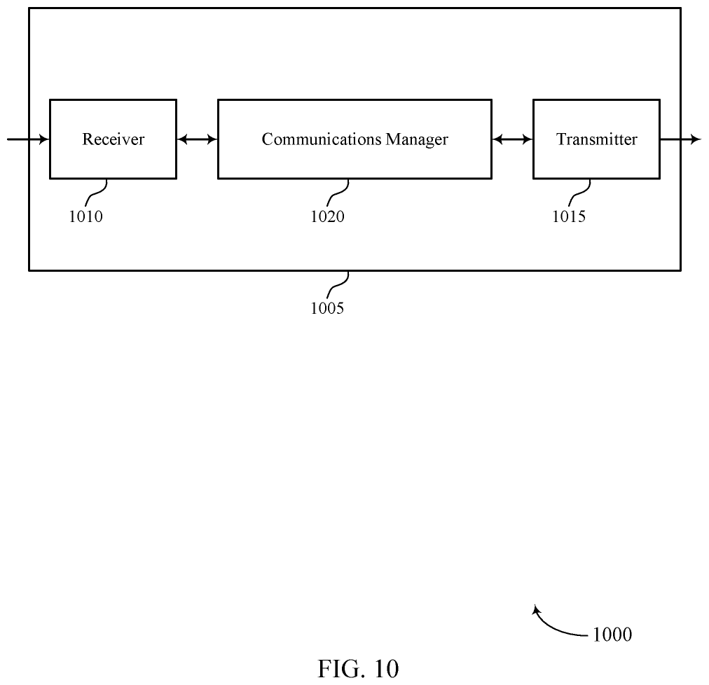

FIG. 10 shows a block diagram 1000 of a device 1005 that supports indicating unused transmit occasions in UCI in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor (not shown), which may be coupled with at least one memory, to, individually or collectively, support or enable the described techniques. Each of these components may be in communication with one another (e.g., via one or more buses (not shown)).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem (not shown).

The communications manager 1020, the receiver 1010, the transmitter 1015, or various combinations thereof or various components thereof may be examples of means for performing various aspects of indicating unused transmit occasions in UCI as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (not shown) (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting configuration information indicating a CG for a UE to transmit a set of multiple PUSCH transmissions including a set of multiple PUSCH repetitions. The communications manager 1020 is capable of, configured to, or operable to support a means for receiving the set of multiple PUSCH repetitions, where one or more of the set of multiple PUSCH repetitions is multiplexed with one or more PUSCH occasion skipping UCI messages according to a priority of each respective one or more PUSCH occasion skipping UCI message.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for transmitting PUSCH occasion skipping UCI with PUSCH repetitions, which may provide for more efficient utilization of communication resources.

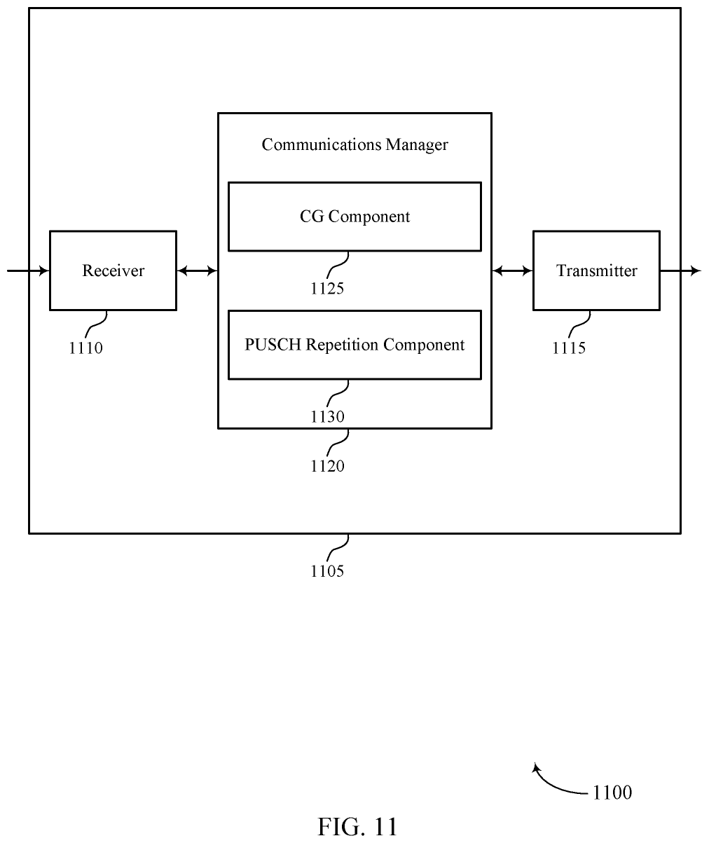

FIG. 11 shows a block diagram 1100 of a device 1105 that supports indicating unused transmit occasions in UCI in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor (not shown), which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem (not shown).

The device 1105, or various components thereof, may be an example of means for performing various aspects of indicating unused transmit occasions in UCI as described herein. For example, the communications manager 1120 may include a CG component 1125 an PUSCH repetition component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The CG component 1125 is capable of, configured to, or operable to support a means for transmitting configuration information indicating a CG for a UE to transmit a set of multiple PUSCH transmissions including a set of multiple PUSCH repetitions. The PUSCH repetition component 1130 is capable of, configured to, or operable to support a means for receiving the set of multiple PUSCH repetitions, where one or more of the set of multiple PUSCH repetitions is multiplexed with one or more PUSCH occasion skipping UCI messages according to a priority of each respective one or more PUSCH occasion skipping UCI message.

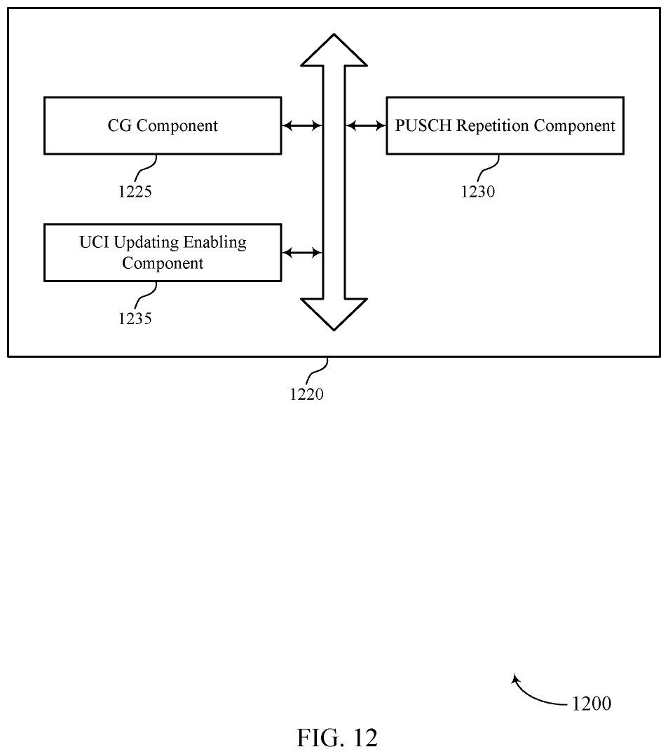

FIG. 12 shows a block diagram 1200 of a communications manager 1220 that supports indicating unused transmit occasions in UCI in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of indicating unused transmit occasions in UCI as described herein. For example, the communications manager 1220 may include a CG component 1225, an PUSCH repetition component 1230, a UCI updating enabling component 1235, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The CG component 1225 is capable of, configured to, or operable to support a means for transmitting configuration information indicating a CG for a UE to transmit a set of multiple PUSCH transmissions including a set of multiple PUSCH repetitions. The PUSCH repetition component 1230 is capable of, configured to, or operable to support a means for receiving the set of multiple PUSCH repetitions, where one or more of the set of multiple PUSCH repetitions is multiplexed with one or more PUSCH occasion skipping UCI messages according to a priority of each respective one or more PUSCH occasion skipping UCI message.

In some examples, the priority of each respective PUSCH occasion skipping UCI message is associated with a respective slot of a corresponding one or more PUSCH repetitions.

In some examples, a first PUSCH occasion skipping UCI message of the one or more PUSCH occasion skipping UCI messages is associated with a highest priority of the one or more PUSCH occasion skipping UCI messages, and the priority of each subsequent PUSCH occasion skipping UCI message is lower than the priority of a respective preceding PUSCH occasion skipping UCI message.

In some examples, to support receiving the set of multiple PUSCH repetitions, the PUSCH repetition component 1230 is capable of, configured to, or operable to support a means for receiving one or more additional uplink control messages associated with the one or more PUSCH repetitions in accordance with the one or more additional uplink control messages having a higher priority than a portion of one or more additional PUSCH occasion skipping UCI message.

In some examples, to support receiving the set of multiple PUSCH repetitions, the PUSCH repetition component 1230 is capable of, configured to, or operable to support a means for receiving at least one PUSCH occasion skipping UCI message of the one or more PUSCH occasion skipping UCI messages in accordance with an expiration of a time gap following a first PUSCH occasion skipping UCI message.

In some examples, to support receiving the set of multiple PUSCH repetitions, the PUSCH repetition component 1230 is capable of, configured to, or operable to support a means for receiving an at least one PUSCH occasion skipping UCI message of the one or more PUSCH occasion skipping UCI messages, where a portion of the at least one PUSCH occasion skipping UCI message is updated in accordance with a change in an transmit occasion skipping estimate.

In some examples, to support receiving the at least one PUSCH occasion skipping UCI message, the PUSCH repetition component 1230 is capable of, configured to, or operable to support a means for receiving the at least one PUSCH occasion skipping UCI message in accordance with two or more PUSCH repetitions of the set of multiple PUSCH repetitions respectively colliding with different UCI messages, where each of the different uplink control information messages has a higher priority than the two or more PUSCH repetitions.

In some examples, to support receiving the at least one PUSCH occasion skipping UCI message, the PUSCH repetition component 1230 is capable of, configured to, or operable to support a means for receiving the at least one PUSCH occasion skipping UCI message in accordance with an expiration of a time gap.

In some examples, the UCI updating enabling component 1235 is capable of, configured to, or operable to support a means for transmitting a radio resource control message indicating whether the UE is permitted to update a content of the one or more PUSCH occasion skipping UCI message.

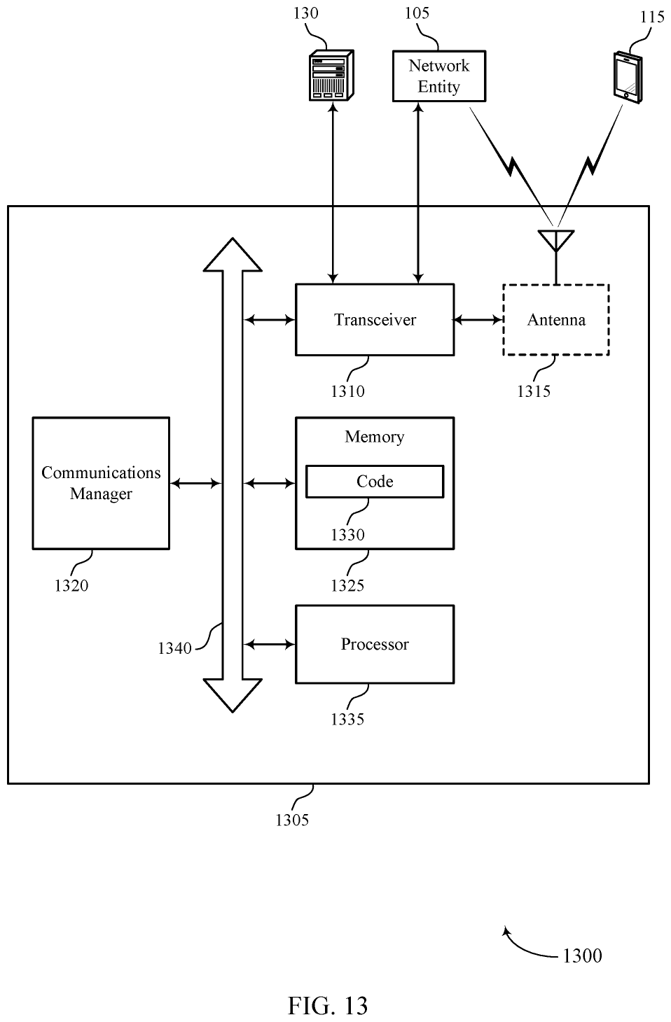

FIG. 13 shows a diagram of a system 1300 including a device 1305 that supports indicating unused transmit occasions in UCI in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem (not shown) to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces (not shown), such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components (not shown) that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors 1335 and the at least one memory 1325 may include multiple memories 1325. One or more of the multiple processors 1335 may be coupled with one or more of the multiple memories 1325 which may, individually or collectively, be configured to perform various functions herein (for example, as part of a processing system).

The at least one processor 1335 may include an intelligent hardware device (not shown) (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting indicating unused transmit occasions in UCI). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors 1335 and the at least one memory 1325 may include multiple memories 1325. One or more of the multiple processors 1335 may be coupled with one or more of the multiple memories 1325, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler (not shown) for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for transmitting configuration information indicating a CG for a UE to transmit a set of multiple PUSCH transmissions including a set of multiple PUSCH repetitions. The communications manager 1320 is capable of, configured to, or operable to support a means for receiving the set of multiple PUSCH repetitions, where one or more of the set of multiple PUSCH repetitions is multiplexed with one or more PUSCH occasion skipping UCI messages according to a priority of each respective one or more PUSCH occasion skipping UCI message.

By including or configuring the communications manager 1320 in accordance with examples as described herein, the device 1305 may support techniques for transmitting PUSCH occasion skipping UCI with PUSCH repetitions, which may provide for improved communication reliability and more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of indicating unused transmit occasions in UCI as described herein, or the at least one processor 1335 and the at least one memory 1325 may be otherwise configured to, individually or collectively, perform or support such operations.

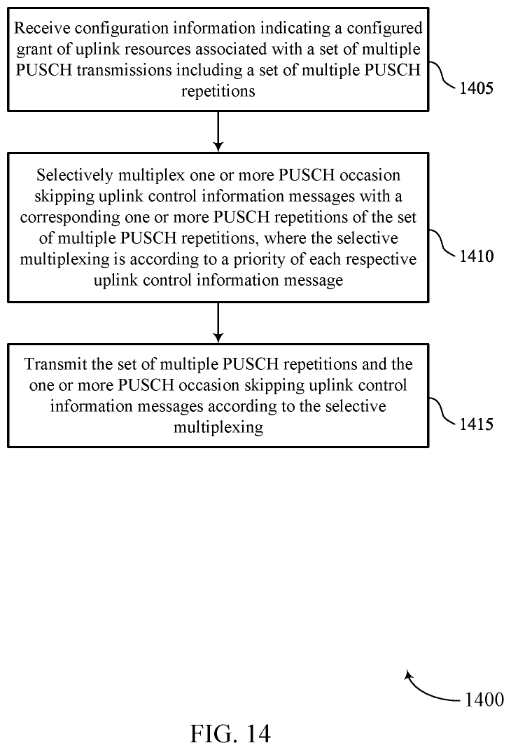

FIG. 14 shows a flowchart illustrating a method 1400 that supports indicating unused transmit occasions in UCI in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving configuration information indicating a CG of uplink resources associated with a set of multiple PUSCH transmissions including a set of multiple PUSCH repetitions. The operations of 1405 may be performed in accordance with examples as disclosed herein. In some examples, aspects of the operations of 1405 may be performed by a CG manager 825 as described with reference to FIG. 8.

At 1410, the method may include selectively multiplexing one or more PUSCH occasion skipping UCI messages with a corresponding one or more PUSCH repetitions of the set of multiple PUSCH repetitions, where the selective multiplexing is according to a priority of each respective UCI message. The operations of 1410 may be performed in accordance with examples as disclosed herein. In some examples, aspects of the operations of 1410 may be performed by a UCI multiplexing manager 830 as described with reference to FIG. 8.

At 1415, the method may include transmitting the set of multiple PUSCH repetitions and the one or more PUSCH occasion skipping UCI messages according to the selective multiplexing. The operations of 1415 may be performed in accordance with examples as disclosed herein. In some examples, aspects of the operations of 1415 may be performed by an PUSCH repetition manager 835 as described with reference to FIG. 8.

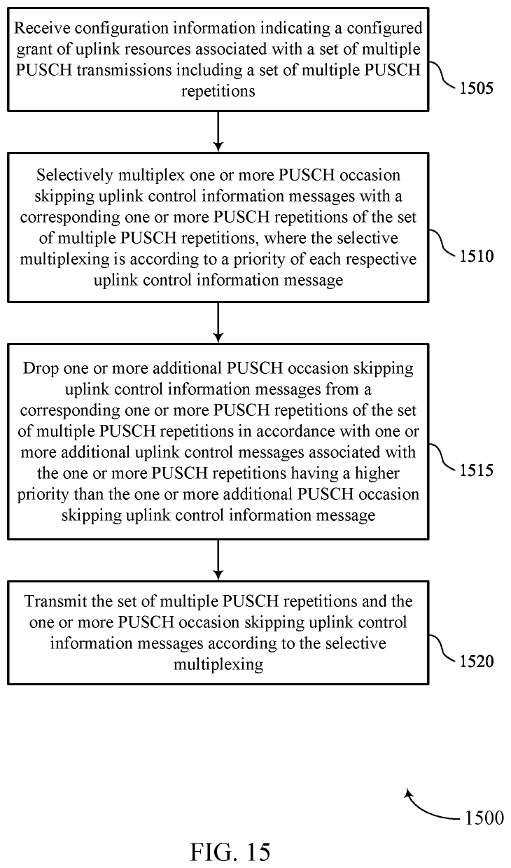

FIG. 15 shows a flowchart illustrating a method 1500 that supports indicating unused transmit occasions in UCI in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving configuration information indicating a CG of uplink resources associated with a set of multiple PUSCH transmissions including a set of multiple PUSCH repetitions. The operations of 1505 may be performed in accordance with examples as disclosed herein. In some examples, aspects of the operations of 1505 may be performed by a CG manager 825 as described with reference to FIG. 8.

At 1510, the method may include selectively multiplexing one or more PUSCH occasion skipping UCI messages with a corresponding one or more PUSCH repetitions of the set of multiple PUSCH repetitions, where the selective multiplexing is according to a priority of each respective UCI message. The operations of 1510 may be performed in accordance with examples as disclosed herein. In some examples, aspects of the operations of 1510 may be performed by a UCI multiplexing manager 830 as described with reference to FIG. 8.

At 1515, the method may include dropping one or more additional PUSCH occasion skipping UCI messages from a corresponding one or more PUSCH repetitions of the set of multiple PUSCH repetitions in accordance with one or more additional uplink control messages associated with the one or more PUSCH repetitions having a higher priority than the one or more additional PUSCH occasion skipping UCI message. The operations of 1515 may be performed in accordance with examples as disclosed herein. In some examples, aspects of the operations of 1515 may be performed by a UCI multiplexing manager 830 as described with reference to FIG. 8.

At 1520, the method may include transmitting the set of multiple PUSCH repetitions and the one or more PUSCH occasion skipping UCI messages according to the selective multiplexing. The operations of 1520 may be performed in accordance with examples as disclosed herein. In some examples, aspects of the operations of 1520 may be performed by an PUSCH repetition manager 835 as described with reference to FIG. 8.

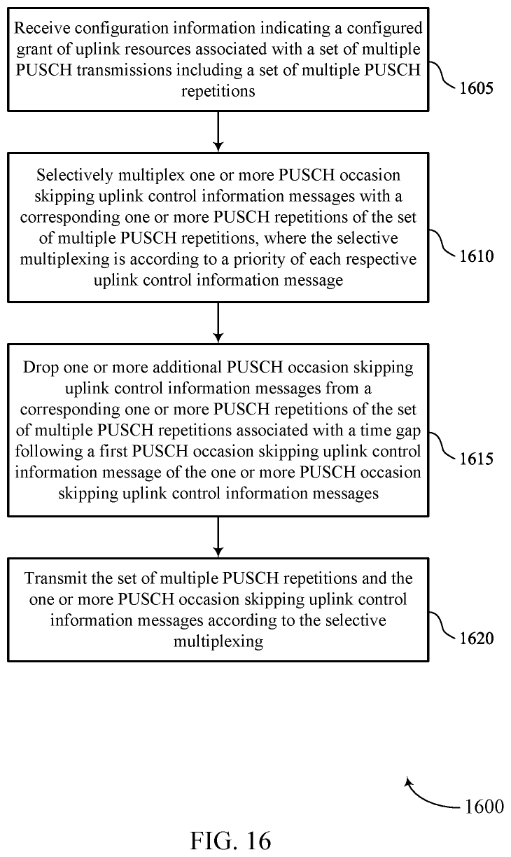

FIG. 16 shows a flowchart illustrating a method 1600 that supports indicating unused transmit occasions in UCI in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving configuration information indicating a CG of uplink resources associated with a set of multiple PUSCH transmissions including a set of multiple PUSCH repetitions. The operations of 1605 may be performed in accordance with examples as disclosed herein. In some examples, aspects of the operations of 1605 may be performed by a CG manager 825 as described with reference to FIG. 8.

At 1610, the method may include selectively multiplexing one or more PUSCH occasion skipping UCI messages with a corresponding one or more PUSCH repetitions of the set of multiple PUSCH repetitions, where the selective multiplexing is according to a priority of each respective UCI message. The operations of 1610 may be performed in accordance with examples as disclosed herein. In some examples, aspects of the operations of 1610 may be performed by a UCI multiplexing manager 830 as described with reference to FIG. 8.

At 1615, the method may include dropping one or more additional PUSCH occasion skipping UCI messages from a corresponding one or more PUSCH repetitions of the set of multiple PUSCH repetitions associated with a time gap following a first PUSCH occasion skipping UCI message of the one or more PUSCH occasion skipping UCI messages. The operations of 1615 may be performed in accordance with examples as disclosed herein. In some examples, aspects of the operations of 1615 may be performed by a UCI multiplexing manager 830 as described with reference to FIG. 8.

At 1620, the method may include transmitting the set of multiple PUSCH repetitions and the one or more PUSCH occasion skipping UCI messages according to the selective multiplexing. The operations of 1620 may be performed in accordance with examples as disclosed herein. In some examples, aspects of the operations of 1620 may be performed by an PUSCH repetition manager 835 as described with reference to FIG. 8.

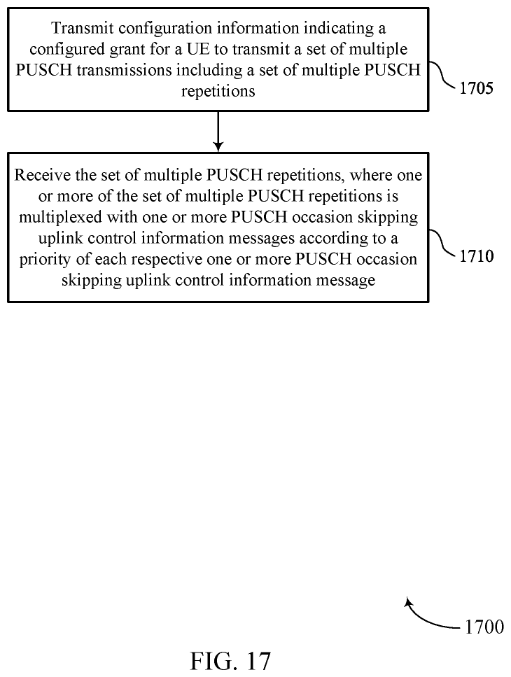

FIG. 17 shows a flowchart illustrating a method 1700 that supports indicating unused transmit occasions in UCI in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting configuration information indicating a CG for a UE to transmit a set of multiple PUSCH transmissions including a set of multiple PUSCH repetitions. The operations of 1705 may be performed in accordance with examples as disclosed herein. In some examples, aspects of the operations of 1705 may be performed by a CG component 1225 as described with reference to FIG. 12.

At 1710, the method may include receiving the set of multiple PUSCH repetitions, where one or more of the set of multiple PUSCH repetitions is multiplexed with one or more PUSCH occasion skipping UCI messages according to a priority of each respective one or more PUSCH occasion skipping UCI message. The operations of 1710 may be performed in accordance with examples as disclosed herein. In some examples, aspects of the operations of 1710 may be performed by an PUSCH repetition component 1230 as described with reference to FIG. 12.

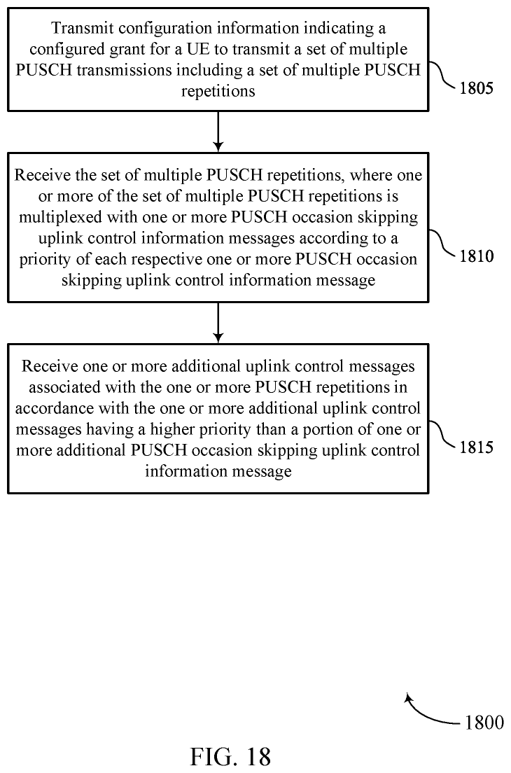

FIG. 18 shows a flowchart illustrating a method 1800 that supports indicating unused transmit occasions in UCI in accordance with aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting configuration information indicating a CG for a UE to transmit a set of multiple PUSCH transmissions including a set of multiple PUSCH repetitions. The operations of 1805 may be performed in accordance with examples as disclosed herein. In some examples, aspects of the operations of 1805 may be performed by a CG component 1225 as described with reference to FIG. 12.

At 1810, the method may include receiving the set of multiple PUSCH repetitions, where one or more of the set of multiple PUSCH repetitions is multiplexed with one or more PUSCH occasion skipping UCI messages according to a priority of each respective one or more PUSCH occasion skipping UCI message. The operations of 1810 may be performed in accordance with examples as disclosed herein. In some examples, aspects of the operations of 1810 may be performed by an PUSCH repetition component 1230 as described with reference to FIG. 12.

At 1815, the method may include receiving one or more additional uplink control messages associated with the one or more PUSCH repetitions in accordance with the one or more additional uplink control messages having a higher priority than a portion of one or more additional PUSCH occasion skipping UCI message. The operations of 1815 may be performed in accordance with examples as disclosed herein. In some examples, aspects of the operations of 1815 may be performed by an PUSCH repetition component 1230 as described with reference to FIG. 12.

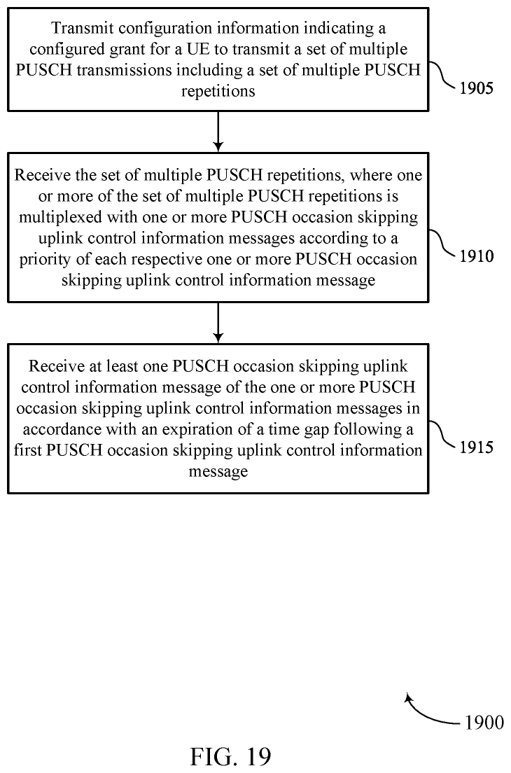

FIG. 19 shows a flowchart illustrating a method 1900 that supports indicating unused transmit occasions in UCI in accordance with aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting configuration information indicating a CG for a UE to transmit a set of multiple PUSCH transmissions including a set of multiple PUSCH repetitions. The operations of 1905 may be performed in accordance with examples as disclosed herein. In some examples, aspects of the operations of 1905 may be performed by a CG component 1225 as described with reference to FIG. 12.

At 1910, the method may include receiving the set of multiple PUSCH repetitions, where one or more of the set of multiple PUSCH repetitions is multiplexed with one or more PUSCH occasion skipping UCI messages according to a priority of each respective one or more PUSCH occasion skipping UCI message. The operations of 1910 may be performed in accordance with examples as disclosed herein. In some examples, aspects of the operations of 1910 may be performed by an PUSCH repetition component 1230 as described with reference to FIG. 12.

At 1915, the method may include receiving at least one PUSCH occasion skipping UCI message of the one or more PUSCH occasion skipping UCI messages in accordance with an expiration of a time gap following a first PUSCH occasion skipping UCI message. The operations of 1915 may be performed in accordance with examples as disclosed herein. In some examples, aspects of the operations of 1915 may be performed by an PUSCH repetition component 1230 as described with reference to FIG. 12.

The following provides an overview of aspects of the present disclosure:

Aspect 1: A method for wireless communications by a UE, comprising: receiving configuration information indicating a configured grant of uplink resources associated with a plurality of PUSCH transmissions including a plurality of PUSCH repetitions; selectively multiplexing one or more PUSCH occasion skipping UCI messages with a corresponding one or more PUSCH repetitions of the plurality of PUSCH repetitions, wherein the selective multiplexing is according to a priority of each respective UCI message; and transmitting the plurality of PUSCH repetitions and the one or more PUSCH occasion skipping UCI messages according to the selective multiplexing.

Aspect 2: The method of aspect 1, wherein the priority of each respective PUSCH occasion skipping UCI message is associated with a respective slot of the corresponding one or more PUSCH repetitions.

Aspect 3: The method of aspect 2, wherein a first PUSCH occasion skipping UCI message of the one or more PUSCH occasion skipping UCI messages is associated with a highest priority of the one or more PUSCH occasion skipping UCI messages, and the priority of each subsequent PUSCH occasion skipping UCI message is lower than the priority of a respective preceding PUSCH occasion skipping UCI message.

Aspect 4: The method of any of aspects 1 through 3, wherein selectively multiplexing the one or more PUSCH occasion skipping UCI messages comprises: dropping one or more additional PUSCH occasion skipping UCI messages from a corresponding one or more PUSCH repetitions of the plurality of PUSCH repetitions in accordance with one or more additional uplink control messages associated with the one or more PUSCH repetitions having a higher priority than the one or more additional PUSCH occasion skipping UCI message.

Aspect 5: The method of any of aspects 1 through 4, wherein selectively multiplexing the one or more PUSCH occasion skipping UCI messages comprises: dropping one or more additional PUSCH occasion skipping UCI messages from a corresponding one or more PUSCH repetitions of the plurality of PUSCH repetitions associated with a time gap following a first PUSCH occasion skipping UCI message of the one or more PUSCH occasion skipping UCI messages.

Aspect 6: The method of aspect 5, wherein selectively multiplexing the one or more PUSCH occasion skipping UCI messages further comprises: selectively multiplexing at least one PUSCH occasion skipping UCI message of the one or more PUSCH occasion skipping UCI messages following the first PUSCH occasion skipping UCI message in accordance with an expiration of the time gap.

Aspect 7: The method of any of aspects 1 through 6, further comprising: updating a content of a portion of the one or more PUSCH occasion skipping UCI messages in accordance with a change in a transmit occasion skipping estimate.

Aspect 8: The method of aspect 7, wherein the content of the portion of the one or more PUSCH occasion skipping UCI messages is updated in accordance with two or more PUSCH repetitions of the plurality of PUSCH repetitions respectively colliding with different UCI messages, each of the different uplink control information messages has a higher priority than the two or more PUSCH repetitions.

Aspect 9: The method of any of aspects 1 through 8, further comprising: maintaining a content of at least one PUSCH occasion skipping UCI message of the one or more PUSCH occasion skipping UCI messages constant during a time gap following a first PUSCH occasion skipping UCI message of the one or more PUSCH occasion skipping UCI messages.

Aspect 10: The method of aspect 9, further comprising: updating a content of at least one PUSCH occasion skipping UCI message of the one or more PUSCH occasion skipping UCI messages in accordance with an expiration of the time gap and a change in a transmit occasion skipping estimate.

Aspect 11: The method of any of aspects 1 through 10, further comprising: receiving a radio resource control message indicating whether the UE is permitted to update a content of the one or more PUSCH occasion skipping UCI messages.

Aspect 12: A method for wireless communications by a network entity, comprising: transmitting configuration information indicating a configured grant for a UE to transmit a plurality of PUSCH transmissions including a plurality of PUSCH repetitions; and receiving the plurality of PUSCH repetitions, wherein one or more of the plurality of PUSCH repetitions is multiplexed with one or more PUSCH occasion skipping UCI messages according to a priority of each respective one or more PUSCH occasion skipping UCI message.

Aspect 13: The method of aspect 12, wherein the priority of each respective PUSCH occasion skipping UCI message is associated with a respective slot of a corresponding one or more PUSCH repetitions.

Aspect 14: The method of aspect 13, wherein a first PUSCH occasion skipping UCI message of the one or more PUSCH occasion skipping UCI messages is associated with a highest priority of the one or more PUSCH occasion skipping UCI messages, and the priority of each subsequent PUSCH occasion skipping UCI message is lower than the priority of a respective preceding PUSCH occasion skipping UCI message.

Aspect 15: The method of any of aspects 12 through 14, wherein receiving the plurality of PUSCH repetitions comprises: receiving one or more additional uplink control messages associated with the one or more PUSCH repetitions in accordance with the one or more additional uplink control messages having a higher priority than a portion of one or more additional PUSCH occasion skipping UCI messages.

Aspect 16: The method of any of aspects 12 through 15, wherein receiving the plurality of PUSCH repetitions comprises: receiving at least one PUSCH occasion skipping UCI message of the one or more PUSCH occasion skipping UCI messages in accordance with an expiration of a time gap following a first PUSCH occasion skipping UCI message.

Aspect 17: The method of any of aspects 12 through 16, wherein receiving the plurality of PUSCH repetitions comprises: receiving an at least one PUSCH occasion skipping UCI message of the one or more PUSCH occasion skipping UCI messages, wherein a portion of the at least one PUSCH occasion skipping UCI message is updated in accordance with a change in an transmit occasion skipping estimate.

Aspect 18: The method of aspect 17, wherein receiving the at least one PUSCH occasion skipping UCI message further comprises: receiving the at least one PUSCH occasion skipping UCI message in accordance with two or more PUSCH repetitions of the plurality of PUSCH repetitions respectively colliding with different UCI messages, wherein each of the different uplink control information messages has a higher priority than the two or more PUSCH repetitions.

Aspect 19: The method of any of aspects 17 through 18, wherein receiving the at least one PUSCH occasion skipping UCI message further comprises: receiving the at least one PUSCH occasion skipping UCI message in accordance with an expiration of a time gap.

Aspect 20: The method of any of aspects 12 through 19, further comprising: transmitting a radio resource control message indicating whether the UE is permitted to update a content of the one or more PUSCH occasion skipping UCI message.

Aspect 21: A UE for wireless communications, comprising one or more memories storing processor-executable code, and one or more processors coupled with the one or more memories and individually or collectively operable to execute the code to cause the UE to perform a method of any of aspects 1 through 11.

Aspect 22: A UE for wireless communications, comprising at least one means for performing a method of any of aspects 1 through 11.

Aspect 23: A non-transitory computer-readable medium storing code for wireless communications, the code comprising instructions executable by a processor to perform a method of any of aspects 1 through 11.

Aspect 24: A network entity for wireless communications, comprising one or more memories storing processor-executable code, and one or more processors coupled with the one or more memories and individually or collectively operable to execute the code to cause the network entity to perform a method of any of aspects 12 through 20.

Aspect 25: A network entity for wireless communications, comprising at least one means for performing a method of any of aspects 12 through 20.

Aspect 26: A non-transitory computer-readable medium storing code for wireless communications, the code comprising instructions executable by a processor to perform a method of any of aspects 12 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information indicating a configured grant of uplink resources associated with a plurality of physical uplink shared channel (PUSCH) transmissions including a plurality of PUSCH repetitions;
selectively multiplex one or more PUSCH occasion skipping uplink control information messages with a corresponding one or more PUSCH repetitions of the plurality of PUSCH repetitions, wherein the selective multiplexing is according to a priority of each respective uplink control information message; and
transmit the plurality of PUSCH repetitions and the one or more PUSCH occasion skipping uplink control information messages according to the selective multiplexing.

2. The UE of claim 1, wherein the priority of each respective PUSCH occasion skipping uplink control information message is associated with a respective slot of the corresponding one or more PUSCH repetitions.

3. The UE of claim 2, wherein a first PUSCH occasion skipping uplink control information message of the one or more PUSCH occasion skipping uplink control information messages is associated with a highest priority of the one or more PUSCH occasion skipping uplink control information messages, and the priority of each subsequent PUSCH occasion skipping uplink control information message is lower than the priority of a respective preceding PUSCH occasion skipping uplink control information message.

4. The UE of claim 1, wherein, to selectively multiplex the one or more PUSCH occasion skipping uplink control information messages, the one or more processors are individually or collectively operable to execute the code to cause the UE to:
drop one or more additional PUSCH occasion skipping uplink control information messages from a corresponding one or more PUSCH repetitions of the plurality of PUSCH repetitions in accordance with one or more additional uplink control messages associated with the one or more PUSCH repetitions having a higher priority than the one or more additional PUSCH occasion skipping uplink control information message.

5. The UE of claim 1, wherein, to selectively multiplex the one or more PUSCH occasion skipping uplink control information messages, the one or more processors are individually or collectively operable to execute the code to cause the UE to:
drop one or more additional PUSCH occasion skipping uplink control information messages from a corresponding one or more PUSCH repetitions of the plurality of PUSCH repetitions associated with a time gap following a first PUSCH occasion skipping uplink control information message of the one or more PUSCH occasion skipping uplink control information messages.

6. The UE of claim 5, wherein, to selectively multiplex the one or more PUSCH occasion skipping uplink control information messages, the one or more processors are individually or collectively further operable to execute the code to cause the UE to:
selectively multiplex at least one PUSCH occasion skipping uplink control information message of the one or more PUSCH occasion skipping uplink control information messages following the first PUSCH occasion skipping uplink control information message in accordance with an expiration of the time gap.

7. The UE of claim 1, wherein the one or more processors are individually or collectively further operable to execute the code to cause the UE to:
update a content of a portion of the one or more PUSCH occasion skipping uplink control information messages in accordance with a change in a transmit occasion skipping estimate.

8. The UE of claim 7, wherein the content of the portion of the one or more PUSCH occasion skipping uplink control information messages is updated in accordance with two or more PUSCH repetitions of the plurality of PUSCH repetitions respectively colliding with different uplink control information messages, and wherein each of the different uplink control information messages has a higher priority than the two or more PUSCH repetitions.

9. The UE of claim 1, wherein the one or more processors are individually or collectively further operable to execute the code to cause the UE to:
maintain a content of at least one PUSCH occasion skipping uplink control information message of the one or more PUSCH occasion skipping uplink control information messages constant during a time gap following a first PUSCH occasion skipping uplink control information message of the one or more PUSCH occasion skipping uplink control information messages.

10. The UE of claim 9, wherein the one or more processors are individually or collectively further operable to execute the code to cause the UE to:
update a content of at least one PUSCH occasion skipping uplink control information message of the one or more PUSCH occasion skipping uplink control information messages in accordance with an expiration of the time gap and a change in a transmit occasion skipping estimate.

11. The UE of claim 1, wherein the one or more processors are individually or collectively further operable to execute the code to cause the UE to:
receive a radio resource control message indicating whether the UE is permitted to update a content of the one or more PUSCH occasion skipping uplink control information messages.

12. A network entity, comprising:
one or more memories storing processor-executable code; and
one or more processors coupled with the one or more memories and individually or collectively operable to execute the code to cause the network entity to:
transmit configuration information indicating a configured grant for a user equipment (UE) to transmit a plurality of physical uplink shared channel (PUSCH) transmissions including a plurality of PUSCH repetitions; and
receive the plurality of PUSCH repetitions, wherein one or more of the plurality of PUSCH repetitions is multiplexed with one or more PUSCH occasion skipping uplink control information messages according to a priority of each respective one or more PUSCH occasion skipping uplink control information message.

13. The network entity of claim 12, wherein the priority of each respective PUSCH occasion skipping uplink control information message is associated with a respective slot of a corresponding one or more PUSCH repetitions.

14. The network entity of claim 13, wherein a first PUSCH occasion skipping uplink control information message of the one or more PUSCH occasion skipping uplink control information messages is associated with a highest priority of the one or more PUSCH occasion skipping uplink control information messages, and the priority of each subsequent PUSCH occasion skipping uplink control information message is lower than the priority of a respective preceding PUSCH occasion skipping uplink control information message.

15. The network entity of claim 12, wherein, to receive the plurality of PUSCH repetitions, the one or more processors are individually or collectively operable to execute the code to cause the network entity to:
receive one or more additional uplink control messages associated with the one or more PUSCH repetitions in accordance with the one or more additional uplink control messages having a higher priority than a portion of one or more additional PUSCH occasion skipping uplink control information message.

16. The network entity of claim 12, wherein, to receive the plurality of PUSCH repetitions, the one or more processors are individually or collectively operable to execute the code to cause the network entity to:
receive at least one PUSCH occasion skipping uplink control information message of the one or more PUSCH occasion skipping uplink control information messages in accordance with an expiration of a time gap following a first PUSCH occasion skipping uplink control information message.

17. The network entity of claim 12, wherein, to receive the plurality of PUSCH repetitions, the one or more processors are individually or collectively operable to execute the code to cause the network entity to:
receive an at least one PUSCH occasion skipping uplink control information message of the one or more PUSCH occasion skipping uplink control information messages, wherein a portion of the at least one PUSCH occasion skipping uplink control information message is updated in accordance with a change in an transmit occasion skipping estimate.

18. The network entity of claim 17, wherein, to receive the at least one PUSCH occasion skipping uplink control information message, the one or more processors are individually or collectively further operable to execute the code to cause the network entity to:
receive the at least one PUSCH occasion skipping uplink control information message in accordance with two or more PUSCH repetitions of the plurality of PUSCH repetitions respectively colliding with different uplink control information messages, wherein each of the different uplink control information messages has a higher priority than the two or more PUSCH repetitions.

19. The network entity of claim 17, wherein, to receive the at least one PUSCH occasion skipping uplink control information message, the one or more processors are individually or collectively further operable to execute the code to cause the network entity to:
receive the at least one PUSCH occasion skipping uplink control information message in accordance with an expiration of a time gap.

20. The network entity of claim 12, wherein the one or more processors are individually or collectively further operable to execute the code to cause the network entity to:
transmit a radio resource control message indicating whether the UE is permitted to update a content of the one or more PUSCH occasion skipping uplink control information message.

21. A method for wireless communications by a user equipment (UE), comprising:
receiving configuration information indicating a configured grant of uplink resources associated with a plurality of physical uplink shared channel (PUSCH) transmissions including a plurality of PUSCH repetitions;
selectively multiplexing one or more PUSCH occasion skipping uplink control information messages with a corresponding one or more PUSCH repetitions of the plurality of PUSCH repetitions, wherein the selective multiplexing is according to a priority of each respective uplink control information message; and
transmitting the plurality of PUSCH repetitions and the one or more PUSCH occasion skipping uplink control information messages according to the selective multiplexing.

22. The method of claim 21, wherein the priority of each respective PUSCH occasion skipping uplink control information message is associated with a respective slot of the corresponding one or more PUSCH repetitions.

23. The method of claim 22, wherein a first PUSCH occasion skipping uplink control information message of the one or more PUSCH occasion skipping uplink control information messages is associated with a highest priority of the one or more PUSCH occasion skipping uplink control information messages, and the priority of each subsequent PUSCH occasion skipping uplink control information message is lower than the priority of a respective preceding PUSCH occasion skipping uplink control information message.

24. The method of claim 21, wherein selectively multiplexing the one or more PUSCH occasion skipping uplink control information messages comprises:
dropping one or more additional PUSCH occasion skipping uplink control information messages from a corresponding one or more PUSCH repetitions of the plurality of PUSCH repetitions in accordance with one or more additional uplink control messages associated with the one or more PUSCH repetitions having a higher priority than the one or more additional PUSCH occasion skipping uplink control information message.

25. The method of claim 21, wherein selectively multiplexing the one or more PUSCH occasion skipping uplink control information messages comprises:
dropping one or more additional PUSCH occasion skipping uplink control information messages from a corresponding one or more PUSCH repetitions of the plurality of PUSCH repetitions associated with a time gap following a first PUSCH occasion skipping uplink control information message of the one or more PUSCH occasion skipping uplink control information messages.

26. The method of claim 25, wherein selectively multiplexing the one or more PUSCH occasion skipping uplink control information messages further comprises:
selectively multiplexing at least one PUSCH occasion skipping uplink control information message of the one or more PUSCH occasion skipping uplink control information messages following the first PUSCH occasion skipping uplink control information message in accordance with an expiration of the time gap.

27. The method of claim 21, further comprising:
updating a content of a portion of the one or more PUSCH occasion skipping uplink control information messages in accordance with a change in a transmit occasion skipping estimate.

28. The method of claim 27, wherein the content of the portion of the one or more PUSCH occasion skipping uplink control information messages is updated in accordance with two or more PUSCH repetitions of the plurality of PUSCH repetitions respectively colliding with different uplink control information messages, and wherein each of the different uplink control information messages has a higher priority than the two or more PUSCH repetitions.

29. The method of claim 21, further comprising:
maintaining a content of at least one PUSCH occasion skipping uplink control information message of the one or more PUSCH occasion skipping uplink control information messages constant during a time gap following a first PUSCH occasion skipping uplink control information message of the one or more PUSCH occasion skipping uplink control information messages.

30. A method for wireless communications by a network entity, comprising:
transmitting configuration information indicating a configured grant for a user equipment (UE) to transmit a plurality of physical uplink shared channel (PUSCH) transmissions including a plurality of PUSCH repetitions; and
receiving the plurality of PUSCH repetitions, wherein one or more of the plurality of PUSCH repetitions is multiplexed with one or more PUSCH occasion skipping uplink control information messages according to a priority of each respective one or more PUSCH occasion skipping uplink control information message.
